(19) United States
(12) Patent Application Publication
(10) Pub. No.: US 2026/0181104 A1
(43) Pub. Date: Jun. 25, 2026

(54) HYBRID MEETINGS

(71) Applicant: GOOGLE LLC, Mountain View, CA (US)

(72) Inventors: Blake Carlton Farmer, Seattle, WA (US); Daniel Edmond Fish, Palo Alto, CA (US); Jacqueline Nicole Roth, Half Moon Bay, CA (US); Travis Miller, Sunnyvale, CA (US); Robert Anderson, Bristol (GB); Lucas Kovar, San Jose, CA (US); Guanlong Qu, Sunnyvale, CA (US); Carlos Hernandez Esteban, Kirkland, WA (US); Pavan Kumar Pavagada Nagaraja, Mountain View, CA (US); Nicole Cecile Baltazar, Belmont, CA (US); Jacob Matthew Cohen, Van Nuys, CA (US); Kexin Ren, San Jose, CA (US); Mohamed Mohy-Eldeen Abdelgany, Irvine, CA (US)

(21) Appl. No.: 19/425,164

(22) Filed: Dec. 18, 2025

Related U.S. Application Data
(60) Provisional application No. 63/737,296, filed on Dec. 20, 2024.

(51) Int. Cl. H04N 7/15

(52) U.S. Cl. CPC H04N 7/15

(57) ABSTRACT

A method including receiving video streams associated with remote participants of a video conference, scaling the video streams to render a corresponding remote participant at a determined scale and vertically shifting the video stream to align an eyeline of the remote participant with an eyeline height, rendering the remote participants using spatial locations, capturing image data representing a local participant, determining a virtual camera viewpoint for video streams based on the spatial location at which a corresponding remote participant is rendered on a display, the virtual camera viewpoint being aligned with the eyeline of the corresponding remote participant, generating streams of the local participant, each video stream corresponding to the virtual camera viewpoint for a respective remote participant, and transmitting each of streams to a device associated with the corresponding remote participant.

### CROSS REFERENCE TO RELATED APPLICATION

This application claims the benefit of U.S. Provisional Application No. 63/737,296, filed Dec. 20, 2024, the disclosure of which is incorporated herein by reference in its entirety.

### BACKGROUND

Conferencing systems, such as video conferencing systems, are used in a variety of settings to provide opportunities for participants to conduct virtual meetings without having to be co-located. Videoconferencing systems, for example, can provide a display, communications link, speakers, and microphones that allow participants to see and communicate with remote participants. Because participants can see each other as they speak, videoconferencing systems can provide for better understanding of discussed topics than written or verbal communication alone. Such videoconferencing systems can also provide for easier scheduling of meetings as not all participants need to be co-located. Further, videoconferencing systems can reduce waste of resources (e.g., time and money) by eliminating the need for travel. Traditional videoconferencing systems typically include a communications system (e.g., a telephone, VoIP system, or the like), a standard video monitor (e.g., a CRT, plasma, HD, LED, or LCD display), a camera, a microphone and speakers.

### SUMMARY

Implementations relate to making video calls feel as natural as talking to someone in person. It tackles two major frustrations with current video conferencing: the feeling of a lack of presence, disconnection and/or the lack of genuine eye contact. To solve this, the technology first places everyone into a shared virtual space, making it look like you're all sitting together around the same table. It does this by removing individual backgrounds and showing participants as life-sized (e.g., by analyzing facial features to determine a natural scale), with their eyes all on the same level. At the same time, it fixes the eye contact problem by creating a unique ‘virtual camera’ for each person you're talking to. So, when you look at a teammate on your screen, they see you looking directly into their eyes, creating a more genuine and engaging connection.

In a general aspect, a device, a system, a non-transitory computer-readable medium (having stored thereon computer executable program code which can be executed on a computer system), and/or a method can perform a process with a method including receiving a plurality of video streams associated with remote participants of a video conference, scaling each of the plurality of video streams to render a corresponding remote participant at a determined scale and vertically shifting the video stream to align an eyeline of the remote participant with a predetermined eyeline height, rendering the plurality of remote participants using spatial locations, capturing image data representing a local participant, determining a virtual camera viewpoint for each of a plurality of video streams based on the spatial location at which a corresponding remote participant is rendered on a display, the virtual camera viewpoint being aligned with the eyeline of the corresponding remote participant, generating the plurality of video streams of the local participant, each video stream corresponding to the virtual camera viewpoint for a respective remote participant, and transmitting each of the plurality of video streams to a device associated with the corresponding remote participant.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A is a diagram illustrating remote participants rendered on a display with aligned eyelines according to at least one example implementation.

FIG. 1B is a diagram illustrating a local participant viewing a display and the corresponding virtual camera viewpoints according to at least one example implementation.

FIG. 1C is a diagram illustrating a local participant according to at least one example implementation.

FIG. 2 is a block diagram illustrating a system flow for processing and rendering video streams from remote participants according to at least one example implementation.

FIG. 3 is a block diagram illustrating a system flow for capturing a local participant and generating video streams for remote participants according to at least one example implementation.

FIG. 4 is a block diagram illustrating a system flow for rendering a virtual camera view according to at least one example implementation.

FIG. 5 is a diagram illustrating a display with a tiled view for a cropped participant according to at least one example implementation.

FIG. 6 is a flowchart illustrating a method for generating a video stream for a remote participant, consistent with disclosed implementations.

FIG. 7 is a flowchart illustrating a method for arranging presentation content on a display according to at least one example implementation.

FIG. 8 is a flowchart illustrating a method for enhancing a video conference according to at least one example implementation.

FIG. 9 is a block diagram of a system for a video conference according to at least one example implementation.

FIG. 10A, FIG. 10B, and FIG. 10C illustrate a block diagram of a multi-camera display arrangement according to at least one example implementation.

FIG. 10D and FIG. 10E illustrate a block diagram of a display order according to at least one example implementation.

It should be noted that these Figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Some implementations can make video calls feel less like looking at a grid of webcams and more like sitting in the same room with other people. A problem with standard video conferencing is the lack of genuine connection. For example, it can be difficult to make real eye contact, conversations can feel awkward, and you lose the sense of being together. This technology solves that by creating a more immersive and natural experience.

The principles of creating a shared virtual space, normalizing participant scale and eyeline, and generating gaze-corrected virtual camera views can be implemented on a range of display hardware. The following detailed description describes the software and processing logic applicable to standard 2D displays and then describes a particularly immersive hardware embodiment, such as a three-dimensional telepresence system, which further enhances the sense of co-presence.

Accordingly, some implementations can make remote participants look like they're really there. Instead of showing everyone in their own messy box with different lighting and camera angles, the system removes the cluttered backgrounds and places everyone in a single, clean virtual space. It intelligently scales each person to be life-sized and adjusts their position so that everyone's eyes are aligned on the same level. This creates the powerful illusion that everyone is sitting together around the same table.

Further, some implementations can fix the eye contact problem. Normally, when you look at someone on your screen, your webcam (usually at the top of the monitor) sees you looking down. To the other person, it doesn't look like you're making eye contact. Accordingly, some implementations can create a personalized “virtual camera” for every single person in the meeting. When you look directly at other participants' face on your screen, the system uses the participants' “camera” to film you from that perspective. To the participant, it looks like you are looking right into her eyes. This allows for natural, direct eye contact with everyone.

An example use case can be team collaboration. For example, a creative team can be brainstorming ideas. With this technology, the conversation flows more naturally. A designer can see when the project manager looks over at the engineer to get their input, making conversational handoffs seamless, just like in a real meeting room. This helps build rapport and makes collaboration more effective.

Another example use case can be remote job interviews. For example, a candidate can make genuine eye contact with the hiring manager. This helps them build a stronger connection and come across as more confident and engaged, rather than appearing to look away from the camera. The interviewer gets a better sense of the candidate's personality and communication skills.

Another example use case can be telehealth and coaching. For example, a therapist or a life coach can better observe a client's subtle non-verbal cues. The direct eye contact helps foster a stronger sense of trust and presence, making the session more effective and supportive for the client.

While traditional videoconferencing systems provide an experience that is closer to a face-to-face meeting than a teleconference (e.g., without video), traditional videoconferencing systems have limitations which detract from a “real life” meeting experience. For example, displays in traditional videoconferences present images in two dimensions and have limited ability to render realistic depth. As a result, participants in a video conference do not have a sense of co-presence with the other participants. In addition, cameras in traditional videoconferencing systems are disposed in a manner such that participants are not able to engage in direct eye contact (e.g., each participant may be looking directly at their display), since the camera does not capture participant images through the display. While some videoconferencing systems provide a virtual-reality like experience for videoconferencing, such videoconferencing systems require participants to wear head-mounted displays, goggles, or 3-D glasses to experience rendering of three-dimensional images. While the methods described herein can be applied to standard displays, a particularly immersive experience can be achieved with specialized hardware, such as the 3D telepresence system. Some technical benefits of the techniques described herein can be, at least, enabling the use of larger more immersive displays, not requiring lots of dedicated cameras, flexibility regarding placement of remote participants on a local display, and flexibility in the overall videoconference UI layout, since view synthesis can put cameras anywhere.

In some implementations, if a participant(s) joins or leaves the meeting, a layout change can be triggered. Otherwise, none of the video feeds change location or move or switch in any way. In other words, in some implementations, remote participants can continuously receive a video stream that is from their own unique perspective throughout the meeting. For example, a first participant should not be presented with a second participant looking at them if, in fact, the second participant is not looking at the first participant. This makes the cue of when the second participant turns to the first participant and start looking at the first participant both salient (people are highly attuned to noticing when they are being looked at) and meaningful. Also meaningful is having breaks in eye contact during a meeting when the conversation is focused on others reduces stress and provides rest.

Accordingly, the implementations disclosed herein are related to a three-dimensional telepresence system providing a more realistic face-to-face experience than traditional videoconferencing systems without the use of head-mounted displays and 3-D glasses. Videoconferencing and image conferencing systems are some examples of telepresence systems. Consistent with disclosed implementations, a three-dimensional telepresence system can include a glasses-free lenticular three-dimensional display that includes a plurality of microlens in a microlens array. According to some implementations, the microlens array may include a plurality of groups (or sub-arrays) of microlenses, each of the plurality of groups (or sub-arrays) includes several microlenses each configured to transmit light across one or more angles and/or each can be configured to display different color pixel values (e.g., RGB pixel values) in one or more different directions.

The use of microlens groups/sub-arrays can be included in a display to show different images at different viewing angles (i.e., that are viewable from different viewing locations). In some implementations of the three-dimensional telepresence system, each of the plurality of microlens groups includes at least two microlenses, and three-dimensional imagery can be produced by projecting a portion (e.g., a first pixel) of a first image in a first direction through the at least one microlens and projecting a portion (e.g., a second pixel) of a second image in a second direction through the at least one other microlens. The second image may be similar to the first image, but the second image may be shifted to simulate parallax thereby creating a three-dimensional stereoscopic image for the viewer.

The three-dimensional telepresence systems disclosed herein can also include a camera assembly having one or multiple camera units. Each camera unit may include an image sensor for capturing visible light (e.g., color), an infrared emitter, and an infrared depth sensor for capturing infrared light originating from the infrared emitter and reflected off the viewer and the objects surrounding the viewer. In some implementations, one or more of the components of the camera unit (e.g., image sensor, infrared emitter, and infrared depth sensor) may not be co-located.

In some implementations, the first terminal of the three-dimensional telepresence system can use a combination of the captured visible light and captured infrared light to generate first terminal image data and first terminal depth data, which is communicated to a second terminal of the three-dimensional telepresence system. In some implementations, the first terminal of the three-dimensional telepresence system can receive second terminal image data and second terminal depth data from the second terminal of the three-dimensional telepresence system, and use the second terminal image data and the second terminal depth data, as well as location data relating to the location of a user with respect to the first terminal (e.g., determined based on the first terminal depth data), to generate three-dimensional stereoscopic images on the display of the first terminal.

Further, implementations are not limited to a single hardware configuration and can be adapted for various systems. For example, the three-dimensional telepresence system described above can be operated in, for example, a two-dimensional (2D) mode. In this 2D mode, the lenticular display features are disabled, and the system renders standard two-dimensional videos for all remote participants. However, the system still leverages its multi-camera array and processing pipeline to perform 3D reconstruction of the local participant, generating and transmitting the unique, gaze-corrected video streams. This allows all participants to experience accurate eye contact, consistent scaling, and eyeline alignment, even when the final output is a conventional 2D image.

For example, the three-dimensional telepresence system described above can be operated in, for example, a mixed mode of operation. The mixed mode can allow for interoperability between different types of terminals. In this scenario, the local system can identify which remote participants are using a compatible 3D telepresence system and which are on standard 2D devices. The system can then render the 3D-capable participants as stereoscopic, three-dimensional images while concurrently rendering the 2D participants as high-quality, segmented video planes within the same shared virtual space. All participants, regardless of their rendering method, can be arranged according to the canonical order and benefit from the normalized eyeline and scale, ensuring a cohesive and integrated experience.

Moreover, the technology can be implemented on a two-dimensional display system. In some implementations, the display system can include a large format display, such as for example a large conference room screen, that has been augmented with a multi-camera array. The multi-camera array can be integrated into the display bezel or provided as an external peripheral, captures the local participant from multiple angles. This multi-view image data is then processed using the same 3D reconstruction and multi-view rendering engines described herein to generate the plurality of gaze-corrected video streams for remote participants. This implementation demonstrates that the described technology (e.g., enabling natural eye contact and a shared spatial context through novel view synthesis) is not dependent on the use of a 3D display and can be deployed on a wide range of existing and future 2D hardware.

In some implementations, the physical environment of the local terminal is intentionally designed to enhance the user experience. This can include a curved table for in-room participants, shaped to improve interpersonal distance, provide a more natural conversation perspective with respect to the other in-room participants, and ensure optimal camera framing for a natural social dynamic. Furthermore, the physical setup may include a “middle wall” that obscures the bottom portion of the display, creating an effective 16:8 aspect ratio for visible pixels. This physical constraint necessitates a user interface design where critical elements are positioned to avoid this obscured region.

In some implementations, the physical environment of the local terminal can include a rectangular table. A rectangular table can allow for acceptable capture of participants. However, a rectangular table can make it difficult for in-person participants to talk amongst themselves (e.g., when the system supports three or more in-room participants). Accordingly, a curved (e.g., strongly curved, overly curved, extremely curved, and the like) table can be used for a better in-room experience (e.g., better for in-room conversation). However, a curved table can result in participants at the edges of the table having an oblique view of the display, being uncomfortably close to the display, and/or for cameras to capture their appearance from the side. Accordingly, a curved table can make it difficult for remote participants to read the facial expressions and body language of in-room participants. Therefore, the table (curved, rectangle, intermediate curve, and the like) used for the physical environment of the local terminal can be selected to balance these considerations.

The user interface can be intentionally organized into distinct zones to provide an intuitive experience. A ‘Call UI’ zone, for example, may be located in the upper-left for call-wide controls, while a persistent, minimized ‘Self-View UI’ occupies the top-right. Other elements, such as call-to-action notifications (e.g., ‘Someone wants to join’), can appear in the top center. A user's name tag may be replaced by a ‘presenter bar’ when they are sharing content. Interactive UI elements like chat messages or emoji reactions can be rendered as ‘Spatial UI,’ appearing contextually near the relevant participant to enhance social connection.

To further support accessibility and communication clarity, the system can provide live captions. In some implementations, ‘spatial captions’ can be rendered directly below the video of the person who is speaking. The system can also define a specific experience for the first participant to join a call, displaying a full-screen view of the local room until a second participant connects, at which point the layout transitions to the immersive multi-participant view. Speaker indication may also be handled with a subtle visual cue, such as highlighting the speaker's name tag, rather than placing a prominent border around their entire video feed.

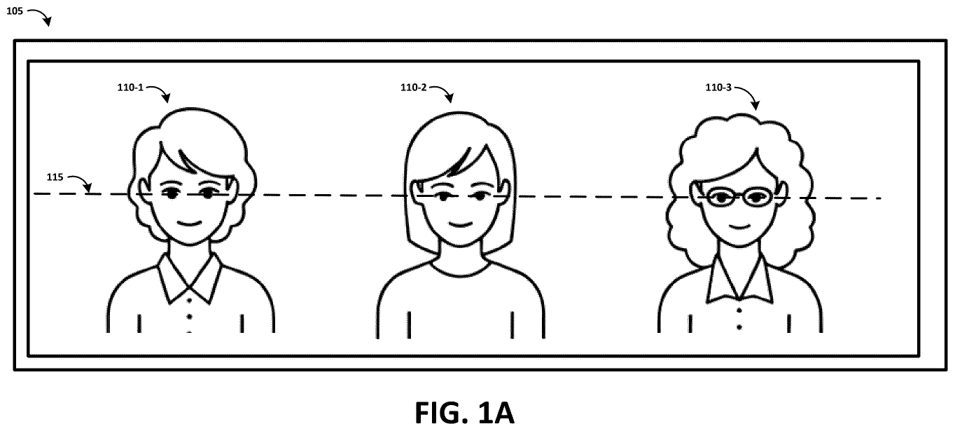

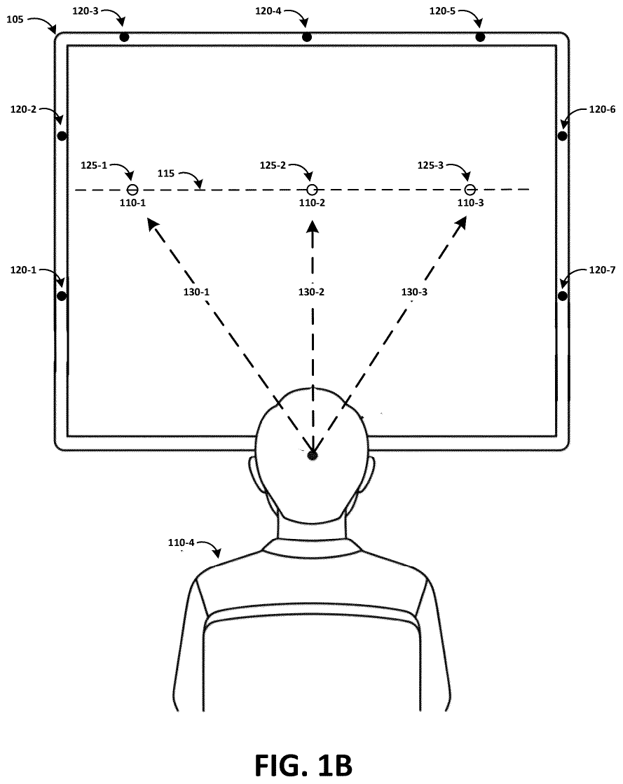

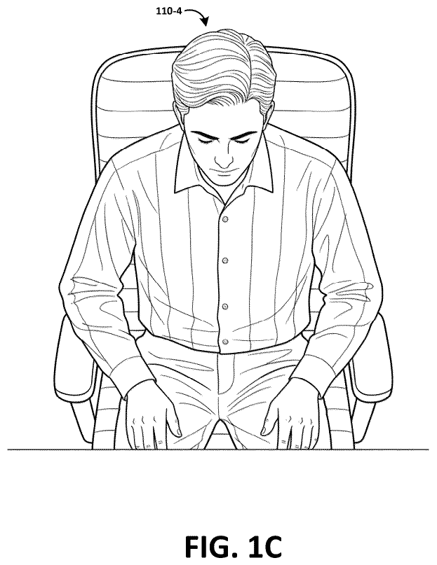

FIG. 1A is a diagram illustrating remote participants rendered on a display with aligned eyelines according to at least one example implementation. As shown in FIG. 1A, a display 105 on which three remote participants 110-1, 110-2, and 110-3 are rendered. In some implementations, a predetermined eyeline height 115, represented by a dashed horizontal line can help create a “real life” meeting experience.

In some implementations, display 105 serves as the primary visual interface for the local participant. For example, display 105 may be a large-format screen designed to present remote participants at a scale that enhances the feeling of co-presence. The display 105 is not merely a monitor for video feeds but an integral component of a system designed to simulate a shared physical environment, acting as a virtual window into the meeting space.

The remote participants 110-1, 110-2, and 110-3 can be visual representations derived from the video streams received from each participant's respective device. Participants 110-1, 110-2, and 110-3 can be rendered having been segmented from their original backgrounds. This segmentation can allow the participants to be placed over a common, unified background on display 105. Using a common, unified background can eliminate the visual clutter of disparate remote environments and reinforce the sense that all participants are occupying the same space.

In some implementations, the rendered remote participants 110-1, 110-2, 110-3 can use a substantially similar scale. The system can process each incoming video stream to render the corresponding participant at a natural, life-sized scale. In some implementations, a natural, life-sized scale can be achieved by analyzing the video feed, for example, by using machine learning to measure interpupillary distance, body shape, pose and/or other scale cues, and then applying a scale factor. Presenting participants 110-1, 110-2, 110-3 at a consistent and natural scale can promote a sense of equity and allows for more natural social interaction, as non-verbal cues are more easily perceived.

The predetermined eyeline height 115 is an important element of the visual layout shown in FIG. 1A. The conceptual horizontal line representing the predetermined eyeline height 115 can be a target vertical position for the eyeline of remote participants rendered on display 105. This height can be configured as a fixed vertical coordinate on the display or calculated dynamically based on, for example, eyeline height (predetermined, typical, flexibly configured, and the like), a percentage of the total display height (e.g., 60% from the bottom edge), and the like to ensure a comfortable and natural viewing angle for the local participant. In some implementations, the target vertical position for the eyeline of remote participants can be based on a local system design (e.g., display size, display position relative to a table or the floor, and the like). In some implementations, the target vertical position for the eyeline of remote participants can be based on the position of the local participants (e.g., based on a local participant eye height relative to a table or the floor, relative to a position of the display, relative to the conference room, and the like). By aligning the eyes of each remote participant 110-1, 110-2, 110-3 along this common line, the system creates the perception that participants 110-1, 110-2, 110-3 are seated at the same level, which can establish natural-feeling gaze interactions and maintain meeting equity.

The alignment shown in FIG. 1A can be implemented using a dynamic normalization process. For example, the system can identify the vertical position of the remote participant's eyes in each incoming video stream. The system can then vertically shift the video stream's rendering position on display 105 until the participant's eyeline coincides with the predetermined eyeline height 115. This continuous adjustment can ensure that the alignment is maintained even as participants move within their own camera's view. In some implementations, the speed at which the shifting and/or rendering position change can be adjusted to provide a comfortable and natural viewing experience.

For example, continuous adjustment can include rendering participants 110-1, 110-2, 110-3 (e.g., as a remote attendee) by shifting the presentation of participant 110-1, 110-2 and/or 110-3 based on the eye position of the local attendee. For example, shifting the presentation of participant 110-1, 110-2 and/or 110-3 can include moving the presentation of 110-1, 110-2 and/or 110-3 up or down such that the local attendee is looking into the eyes of 110-1, 110-2 and/or 110-3 when rendered. In some implementations, shifting the presentation of 110-1, 110-2 and/or 110-3 can include moving the presentation of remote attendee 110-1, 110-2 and/or 110-3 left or right to center the presentation in the associated tile. In some implementations, shifting the presentation of 110-1, 110-2 and/or 110-3 can include fading a boundary of the presentation of the remote attendee. For example, moving the participant 110-1, 110-2 and/or 110-3 up or down could cause torso truncation and/or other video clipping because of not having any pixels to render. Fading can include extending and lightening pixels to extend the missing portion of, for example, the remote attendee torso.

In addition to the vertical alignment, the remote participants 110-1, 110-2, 110-3 can be arranged horizontally at specific spatial locations on display 105. This arrangement is not arbitrary but is managed to ensure a logical and consistent layout. In some implementations, these spatial locations can be determined by a canonical ordering service, which maintains the relative position of participants from every viewer's perspective, further enhancing the stability and intuitiveness of the virtual environment.

The spatial locations at which the remote participants 110-1, 110-2, 110-3 are rendered can be an input for viewpoint determination as illustrated in FIG. 1B. The system can use these on-screen locations to determine the corresponding viewpoints for a plurality of virtual cameras that capture the local participant, thereby enabling the generation of accurate gaze cues and completing the immersive communication loop.

FIG. 1B is a diagram illustrating a local participant viewing a display and the corresponding virtual camera viewpoints according to at least one example implementation. In the example of FIG. 1B, the system can capture the local participant and generate a plurality of video streams to enable accurate eye contact with remote participants. As shown in FIG. 1B, a local participant 110-4 can be viewing the display 105, on which remote participants 110-1, 110-2, and 110-3 are rendered with their eyelines aligned along the predetermined eyeline height 115, as established in FIG. 1A.

The local participant 110-4 can be interacting with the immersive scene by looking at the different remote participants 110-1, 110-2, 110-3 on display 105. In conventional systems, a single, fixed camera would capture the local participant 110-4 looking down (see FIG. 1C) and away from the camera's lens, resulting in a disconnected experience for the remote viewers. Some implementations can overcome this by creating personalized viewpoints for each remote participant.

In some implementations, a plurality of virtual camera viewpoints 125-1, 125-2, and 125-3 can be created. These are not physical cameras but are instead dynamically calculated perspectives from which a video stream of the local participant 110-4 is synthesized. A virtual camera viewpoint 125-1, 125-2, 125-3 can be generated for each remote participant 110-1, 110-2, 110-3 shown on display 105, establishing a one-to-one correspondence between the viewer and the view received by the viewer.

The location of each virtual camera viewpoint 125-1, 125-2, 125-3 can be based on a position determined for each viewpoint. Each viewpoint can be based on the specific spatial location at which the corresponding remote participant is rendered on display 105. As shown in FIG. 1B, the virtual camera viewpoint 125-1 can be vertically aligned with remote participant 110-1, viewpoint 125-2 with participant 110-2, and so on. Furthermore, each viewpoint can be positioned to be aligned with the predetermined eyeline height 115, ensuring the synthesized view will create a direct line of sight.

The viewpoint vectors 130-1, 130-2, and 130-3 represent the lines of sight, or gaze cues, of the local participant 110-4. When the local participant 110-4 looks at remote participant 110-1, their gaze naturally follows the vector 130-1. The system leverages this interaction by using the virtual camera at viewpoint 125-1 to render the video stream that is transmitted exclusively to remote participant 110-1. This creates a closed loop where the act of looking directly at someone on screen generates a video feed for that person that perfectly mirrors the intended eye contact.

This process results in the generation and transmission of multiple, independent video streams of the local participant 110-4. In some implementations, each of these streams can be unique. In other words, the video sent to remote participant 110-1, generated from viewpoint 125-1, will be slightly different from the video sent to remote participant 110-2, which is generated from viewpoint 125-2. This multi-stream capability can provide a personal visual experience for every participant in the conference.

The system's ability to generate these novel views is enabled by an underlying 3D reconstruction of the local participant 110-4. For example, image data can be captured from multiple physical cameras 120-1, 120-2, 120-3, 120-4, 120-5, 120-6, 120-7 and processed to create a 3D model in real time. The multiple video streams shown conceptually in FIG. 1B are then rendered by projecting this 3D model from the various calculated virtual camera viewpoints 125-1, 125-2, 125-3. In FIG. 1B, seven (7) cameras are illustrated. However, implementations are not limited to seven cameras. In some implementations, fewer cameras (e.g., six) or more (e.g., eight) cameras can be used. In addition, cameras 120-1, 120-2, 120-3, 120-4, 120-5, 120-6, 120-7 are illustrated as being along the left side, right side, and top of display 105. However, implementations can include cameras in other locations (e.g., any combination of along the sides, along the top, and/or along the bottom) of display 105. Cameras 120-1, 120-2, 120-3, 120-4, 120-5, 120-6, 120-7 are illustrated in several potential spatial locations along the top of the display 105. However, implementations are not limited to this number or arrangement. For example, fewer or more cameras could be used, and they could be placed in other locations, such as along the sides or bottom of the display, to achieve the necessary multi-view capture.

FIG. 1C is a diagram illustrating a local participant according to at least one example implementation. FIG. 1C can be depiction of the individual whose image is being captured and processed to generate multiple video streams described in relation to FIG. 1B. The local participant 110-4 is shown in a seated position, representing a typical user interacting with the video conferencing terminal during a meeting.

As shown in FIG. 1C, the local participant 110-4 looks slightly downward, a posture consistent with viewing the remote participants rendered on display 105. This illustration serves to highlight the technical problem with directly using physical cameras associated with display 105. A conventional, single camera placed above the display would capture this downward gaze, failing to create a sense of direct eye contact for the remote viewers. FIG. 1C thus represents the raw visual input that the system's novel view generation process transforms into a plurality of gaze-corrected output streams.

In some implementations, the captured image data of this participant can function as the foundational data from which the system synthesizes the various virtual camera viewpoints 125-1, 125-2, 125-3. By capturing the participant 110-4 from multiple angles and generating a real-time model, the system is able to render the unique, perspective-correct video feeds that are transmitted to each remote participant, thereby completing the immersive communication loop.

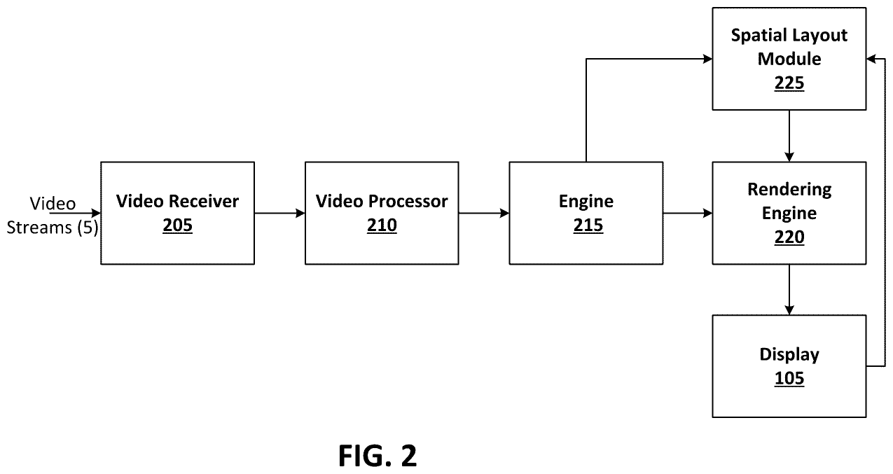

FIG. 2 is a block diagram illustrating a system flow for processing and rendering video streams from remote participants according to at least one example implementation. As shown in FIG. 2, the dataflow includes a video receiver 205 block, a video processor 210 block, an engine 215 block, a rendering engine 220 block, a spatial layout module 225 block, and the display 105 block. The dataflow of FIG. 2 relates to processing incoming video streams from remote participants. In some implementations, this process is to receive multiple, disparate video feeds and transform them into a cohesive, normalized, and spatially organized scene, as visually depicted in FIG. 1A. This system addresses the common problem in video conferencing where remote attendees appear in separate, inconsistent tiles, detracting from a sense of shared presence.

The dataflow of FIG. 2 can address several technical challenges associated with hybrid meetings. Remote participants join from a wide variety of environments, using different cameras, lighting, and framing. Without processing, these inconsistencies create a disjointed visual experience. The components within this dataflow can be configured to analyze each stream individually and apply a series of corrections to normalize key visual attributes, such as the participant's scale, eyeline height, and background, thereby creating a visually unified group of participants.

The dataflow of FIG. 2 relates to processing incoming video streams (also referred to herein as a plurality of first video streams) from remote participants. In some implementations, this process is to receive multiple, disparate video feeds and transform them into a cohesive, normalized, and spatially organized scene, as visually depicted in FIG. 1A. This system addresses the common problem in video conferencing where remote attendees appear in separate, inconsistent tiles, detracting from a sense of shared presence.

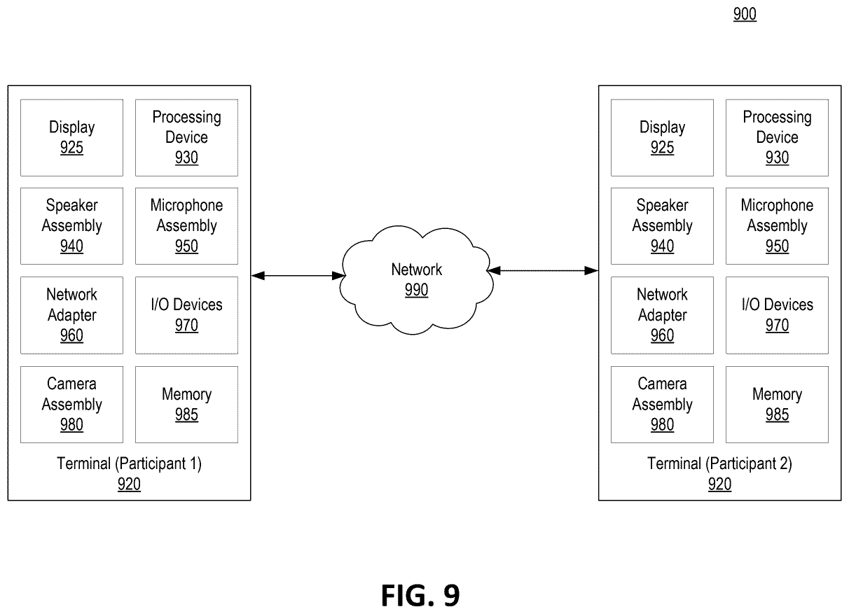

The video streams 5 can represent the initial, raw input to the rendering pipeline. Video streams 5 can be a plurality of independent video feeds, each originating from the camera of a remote participant's device. Video streams 5 can be communicated over a network (e.g., network 990 of FIG. 9) to the local terminal. As the raw input, these streams can include the unprocessed view of each remote participant within their respective physical environments, including their original backgrounds, lighting conditions, and camera framing.

Remote participants may join from various devices (e.g., laptops with webcams, dedicated conference room systems). Therefore, video streams 5 can be inconsistent. Video streams 5 can differ significantly in terms of resolution, lighting quality, color balance, and how the participant is framed (e.g., a close-up view showing only a head versus a wider view showing the full torso).

The content of video streams 5 can serve as the input data for creating immersive experiences. Each video streams 5 can be individually fed into the video processor 210, which analyzes the visual information to identify the participant, determine their eyeline position, and calculate the necessary scaling factor. The system extracts the image of the participant from each of the video streams 5, discards the inconsistent background information, and uses the extracted visual data as the basis for the normalized rendering shown in FIG. 1A.

In some implementations, video receiver 205 can function as the initial entry point for incoming remote participant data into the local terminal's processing pipeline. Video receiver 205 can be configured to manage the reception of the plurality of video streams 5 from a network communicatively coupled between a local device and at least one remote device. In this capacity, video receiver 205 can function as a gateway, responsible for establishing and maintaining communication sessions with each remote participant's device. The video receiver 205 can receive the raw, and often compressed, video data, preparing it for the subsequent normalization and rendering stages.

In some implementations, video receiver 205 can be implemented as a software module configured to control the network transport and session management protocols used for real-time communication. This can include protocols such as the Real-time Transport Protocol (RTP) for media delivery and associated control protocols.

Further, the video receiver 205 can be configured to control the initial stages of media decoding. The incoming video streams 5 are typically compressed using a video codec, such as H.264, VP9, or AV1, to minimize bandwidth requirements. The video receiver 205 can be configured to parse session description information to identify the specific codec used for each stream. The video receiver 205 can be configured to direct the compressed data to the appropriate software or hardware decoder, which will decompress the video frames into a raw, processable format.

For example, in a call with two remote participants Participant A can be using a laptop and sending a 720p stream encoded with the VP9 codec, while Participant B can be in a conference room sending a 1080p stream encoded with H.264. The video receiver 205 can establish and manage two separate data sessions. It receives packetized streams from both participants, uses its jitter buffer to smooth out any network-related timing issues, and identifies that one stream requires a VP9 decoder and the other an H.264 decoder. It then forwards the distinct, decompressed video frames for Participant A and Participant B to the video processor 210, while maintaining metadata that associates each frame with its source participant.

In some implementations, video processor 210 can be configured to transform the raw, heterogeneous video feeds corresponding to video streams 5 into normalized assets suitable for creating a cohesive virtual space. For example, video processor 210 can be configured to receive the decompressed video frames and performs a series of computationally intensive, real-time analyses and manipulations. For example, video processor 210 can be configured to segment each participant from their background, calculate and apply a scaling factor to render them at a natural size, and vertically shift the video to align their eyeline with a common height.

In some implementations, video processor 210 can be configured to perform background segmentation. For example, a machine learning model, such as a convolutional neural network trained for portrait segmentation, can be used to perform background segmentation on each video stream. This model can analyze each frame to distinguish the human participant from their physical environment, generating a corresponding alpha mask. This mask effectively separates image portions corresponding to the participant, allowing the image to be composited over a unified background later in the pipeline. The quality of this segmentation should be sufficient to avoid visual artifacts like haloing or incorrect cropping, particularly around complex features like hair.

After segmentation, the video processor 210 can perform scale and position normalization. The video processor 210 can be configured to use a machine learning model for facial landmark detection to identify the participant's eyes and measure their interpupillary distance in pixels. This measurement can be used as a reliable proxy for calculating the participant's distance from their camera. For example, the system can use a pre-established model that correlates the number of pixels between a person's pupils with their z-depth (distance from the camera), assuming an average human interpupillary distance. By comparing the measured pixel distance to this model, the system can estimate the z-depth of the participant and compute a corresponding scale factor to resize the segmented participant to appear life-sized. Concurrently, the vertical coordinate of the detected eyeline is used to calculate the necessary vertical shift to move the participant's image up or down, aligning their eyes precisely with the predetermined eyeline height 115.

Continuing the example, the video processor 210 can receive the 720p stream of Participant A and the 1080p stream of Participant B. Video processor 210 can apply a segmentation model to both, creating a clean cutout of Participant A from their home office and Participant B from their conference room. The video processor 210 ML analysis can determine that Participant A is sitting closer to their laptop camera than Participant B is to the room camera. Video processor 210 can calculate a smaller scaling factor for Participant A and a larger scaling factor for Participant B to render them both at a consistent, natural scale. video processor 210 can detect that Participant A's eyeline is high in their frame, while Participant B's is low. Video processor 210 can calculate a downward vertical shift for Participant A and an upward vertical shift for Participant B, ensuring both their eyelines will align perfectly when rendered.

The output of the video processor 210 can be a set of processed data packets, one for each remote participant. Each packet can include the now-segmented video stream of the participant, along with metadata specifying the final calculated scale and vertical position. By transforming a collection of disparate video feeds into a set of standardized, compositing-ready assets, the video processor 210 can provide the input to the engine 215 and rendering engine 220.

The engine 215 can be configured to function as the central orchestration and logic hub for the remote participant rendering pipeline. engine 215 does not directly manipulate video frames but instead manages the state of the video conference and coordinates the flow of data and instructions. Engine 215 can receive the normalized video assets and associated metadata from the video processor 210 and can be configured to determine the final arrangement of these assets by interacting with the spatial layout module 225 before passing a complete scene description to the rendering engine 220.

In some implementations, engine 215 can be configured to maintain a real-time state model of the meeting. This model can include information such as the number of active participants, their unique identifiers, and whether presentation content is being shared. When new processed video assets arrive, engine 215 can query the spatial layout module 225, providing engine 215 with the current meeting state. The spatial layout module 225, in turn, uses this state information to apply its layout rules (e.g., canonical ordering) and returns a precise layout map. This map can assign a specific on-screen spatial location (e.g., x/y coordinates, z-depth for scaling effects) to each participant's unique identifier.

In some implementations, the engine 215 can be configured to apply conditional logic based on the metadata received from the video processor 210. For example, if the metadata for a particular video stream indicates a high cropping level (e.g., the view is primarily of a head), engine 215 can execute a fallback display logic. For example, the fallback display logic can include rendering the remote participant in a tiled view having a localized virtual background. In some implementations, the localized virtual background can have minimal contrast as compared to the shared background. In this case, engine 215 can be configured to instruct the rendering engine 220 to render that specific participant within a distinct tiled view with a localized background, rather than directly on the unified background. The engine 215 thus acts as a decision-making component, ensuring the final rendering is not only spatially organized but also visually robust.

When a remote participant's video feed results in a segmented image with truncated edges (e.g., the bottom of the torso is cut off by the camera frame), the system can apply a visual effect to make the crop appear more natural, intentional, and to minimize edge distraction. Instead of a hard cut-off, a soft, gradual fade can be applied to the truncated edge. In some implementations, this fade may have a curved shape and is intelligently positioned relative to the user's body. The treatment for different truncations may vary; for example, a fade applied to the top edge of a frame may be smaller or more subtle to avoid interfering with the participant's face, while a more pronounced fade can be used on side or bottom edges.

The system can also continuously evaluate each incoming video stream against a set of quality parameters to ensure it meets a minimum threshold for the immersive experience. Beyond just poor cropping, this evaluation can include analyzing factors such as video resolution, lighting conditions, user orientation, and excessive user motion. For example, the system may quantify lighting by analyzing the histogram of the video frame to detect under- or over-exposure, and measure excessive motion by calculating the magnitude of optical flow between consecutive frames. To evaluate cropping, the system can use a machine learning model to identify both the head and torso and calculate the ratio of visible torso height to head height. If a stream is determined to be of insufficient quality (e.g., the head-to-torso ratio falls below a predetermined threshold, indicating a head-only view, or motion vectors exceed a limit), the system can trigger a fallback. Instead of being rendered in the shared virtual space, in some implementations, that specific participant can be transitioned to the tiled view with a localized background, preserving the integrity of the immersive experience for the other participants. Instead of being rendered in the shared virtual space, in some implementations, that specific participant can be rendered with the unmodified video feed including, for example, the original background.

To provide flexibility, some implementations can include manual user controls, accessible via a touch controller or similar interface. A user may be provided with a control to toggle between the immersive experience and a standard grid-based layout. As discussed above, the eyeline can be automatically adjusted. However, another control can allow for global eyeline adjustment, enabling the user to manually shift the vertical position of the shared eyeline for all remote participants to improve comfort and the sense of co-presence.

Continuing the example, engine 215 can receive the normalized, segmented video assets for Participant A and Participant B. engine 215 can query the spatial layout module 225 for a two-person layout. The spatial layout module 225 can consult its canonical ordering service and returns a layout map specifying that Participant A should be rendered at spatial location X1 (on the left) and Participant B at spatial location X2 (on the right). Engine 215 can then assemble two instruction packets including one containing Participant A's video and X1 coordinate, and another containing Participant B's video and X2 coordinate. engine 215 then forwards these complete instructions to the rendering engine 220.

Rendering engine 220 can be configured to execute the instructions from engine 215 to create the final composite image that is sent to the display 105. Rendering engine 220 can be configured to receive the normalized and spatially assigned video assets and perform the pixel-level operations to combine them into a single, cohesive video frame. Rendering engine 220 can function to translate the logical scene description into the visual output viewed by the local participant, effectively painting the final picture for each frame of the video conference.

In some implementations, rendering engine 220 can be configured to operate as a layered compositor. For each frame, rendering engine 220 can first render the unified background, which can be, for example, a static image, a procedurally generated gradient, or a more complex virtual environment. Then, for each remote participant, rendering engine 220 can use the alpha mask (provided by the video processor 210) to composite the segmented participant's video over this background. The x/y coordinates for this composition can be taken directly from the layout map provided by engine 215. The rendering engine 220 can be configured to process aspects of alpha blending to ensure the edges of the segmented participants appear smooth and natural against the new background.

In addition to basic composition, the rendering engine 220 can apply final visual enhancements and effects. For example, rendering engine 220 can be configured to apply machine learning-based corrections, such as a portrait lighting model, to normalize the appearance of participants and create a more cohesive look. In some implementations rendering engine 220 can be configured to execute conditional rendering logic. For example, rendering engine 220 can apply a visual fade effect to truncated torso edges to, for example, soften an image crop. If engine 215 has flagged a participant for the fallback tiled view, the rendering engine 220 can render that participant within a separate rectangle containing a localized background, rather than directly onto the main unified background.

Continuing the example, the rendering engine 220 can receive the instructions to place Participant A at coordinate X1 and Participant B at coordinate X2. Rendering engine 220 can begin by rendering the unified background across the entire frame. Rendering engine 220 can then apply a subtle color correction to both participants' video streams to better match their appearance. Using the provided alpha masks, rendering engine 220 can composite the image of Participant A at location X1 and Participant B at location X2. Because Participant A's video feed was determined to have a truncated torso, the rendering engine 220 can also applies a soft fade effect to the bottom edge of their rendered image.

The final completed frame is then sent to display 105. The output of the rendering engine 220 can be a continuous stream of fully composited video frames, delivered to the display 105 at a rate sufficient for smooth motion (e.g., 30 or 60 frames per second).

The spatial layout module 225 can be a specialized component that functions as the architect of the virtual meeting space. In some implementations, spatial layout module 225 can be configured to determine the on-screen spatial location for each remote participant. Interacting with engine 215, spatial layout module 225, can receive the current state of the meeting (e.g., the number of participants) and return a deterministic layout map. Spatial layout module 225 can be configured to ensure that the arrangement of participants is not random but follows a set of rules designed to create a spatially consistent, intuitive, and natural-feeling virtual environment.

In some implementations, the spatial layout module 225 can be configured to implement a canonical ordering service. This service assigns a persistent, relative order to all participants in the video conference, creating a virtual roundtable. For instance, upon a participant joining the call, a central conference management server may assign them a unique, persistent slot in an ordered list (e.g., based on join sequence, alphabetical order, or a host-defined order). In some implementations, the persistent slot screen layout can use heuristics to optimally group participants to maximize screen utilization and/or create an attractive layout. This ordered list is then communicated to all participants' terminals, which use it as a shared and authoritative frame of reference for rendering. For example, in a call with participants A, B, C, and D, the service ensures that from A's perspective, B, C, and D appear in a specific order, and from B's perspective, C, D, and A appear in the same relative order. This consistent ordering is critical to the system's ability to provide representative third-party gaze cues, as it makes participants' head turns and attention shifts predictable and meaningful to all viewers. In other words, when participant X turns to look at participant Y the head turn should be in the correct direction from the perspective of every user and every video feed layout used on all terminals in the call.

Spatial layout module 225 can be adaptive. For example, if the meeting state changes, the spatial layout module 225 can recalculate the layout accordingly. For example, if presentation content is introduced, spatial layout module 225 can allocate one or more spatial locations to the content and arrange the human participants in the remaining slots according to the canonical order. Spatial layout module 225 can also apply more subtle adjustments, such as the scale and vertical offsets, to position participants along a virtual curve, enhancing the perception of depth and the feeling of being seated around a table.

Continuing the example with Participant A and Participant B, engine 215 can inform the spatial layout module 225 that there are two active participants. Spatial layout module 225 can consult its canonical ordering service, which dictates that Participant A should be positioned to the left of Participant B. Spatial layout module 225 can then calculate the specific coordinates for a two-person layout, centering the pair on the screen while maintaining appropriate spacing. spatial layout module 225 can return a layout map to engine 215 that definitively assigns Participant A to a location on the left side of the display and Participant B to a location on the right.

Some implementations can include a canonical ordering of the participants that establishes a “world-centric” or meeting-centric frame of reference, where the ordering of participants can be constant for most viewers. This is fundamentally different from the “ego-centric” or self-centered layouts common in other multi-user applications, such as online poker. In a typical online poker interface, a player always sees themselves in the same seat (e.g., bottom-center), and the other players are arranged relative to that fixed personal viewpoint. If another player were to view the same table, they would see themselves in the bottom-center seat, and the arrangement of all other players would be rotated accordingly. Such an ego-centric model does not provide a shared spatial context.

By contrast, canonical ordering can ensure that if Participant B is to the immediate left of Participant C, they are rendered in that relative position on the screen of every other participant in the meeting. This shared context can enable representative third-party gaze cues. When one participant looks at another, their head turn is interpretable by everyone in the meeting because the target of their gaze occupies the same relative position in every participant's view. In an ego-centric model, a head turn would be ambiguous to third-party observers, as the target participant would be in a different relative location on each observer's screen.

The canonical order can be established by a central conference management service when the meeting begins or as participants join. The service can assign each participant a persistent slot in a sequence (e.g., based on join order, alphabetical name order, or a pre-configured list). This ordered list is then distributed to each participant's terminal. Each terminal can render the remote participants on its display according to this shared sequence, creating a virtual roundtable. For example, the sequence can be mapped to spatial locations on the display from left to right, wrapping around as needed for different viewers.

For example, consider a meeting with four participants: Alice, Bob, Charlie, and David, with a canonical order of [Alice, Bob, Charlie, David]. From Alice's perspective, she will see Bob, Charlie, and David arranged in order on her screen. From Bob's perspective, his terminal will render the other participants according to the same sequence, wrapping around to show Charlie, David, and then Alice. From every viewpoint, Charlie is always rendered immediately after Bob in the sequence. Therefore, if Alice sees Bob turn his head towards Charlie, David will also see Bob turn his head toward Charlie, because Charlie occupies the same relative position from everyone's perspective.

Providing each participant with unique video feeds from their rendered position is important in providing accurate third-party gaze cues in combination with canonical ordering. For example, consider the previous meeting with [Alice, Bob, Charlie, David], and consider the case where Alice stops looking at David and starts looking at Bob. On her screen the ordering is (Bob, Charlie, David). Charlie is placed between Bob and David in the canonical ordering, and he also receives a video feed from Alice using a virtual camera located where he is rendered. Therefore, he sees Alice as at first looking to her right (since David is displayed to Charlie's right on her screen) with Alice then turning her head to her left (since Bob is displayed to Charlie's left on Alice's screen). From Charlie's perspective, the ordering on his screen is (David, Alice, Bob). Her initial gaze being to her right aligns with David's location on Charlie's screen, because her orientation is flipped such that her right is Charlie's left. Then, if she shifts her attention to Bob, her gaze moves to her left as earlier described, which also matches Bob being rendered to the right on Charlie's screen. Alice's directional gaze cues are accurate from Charlie's perspective.

This persistent, shared spatial mapping makes the virtual interaction space feel more stable and predictable, akin to a physical meeting room where people do not arbitrarily change seats. It allows participants to build a mental model of the virtual room and leverages natural social cues, such as interpreting conversational flow by watching who is looking at whom. This stability is a key enabler of the system's ability to create a more natural and immersive sense of co-presence, moving beyond a simple grid of disconnected video feeds.

In some implementations, the system moves beyond rendering all participants at a single, uniform “life-sized” scale and instead implements a “relative veridical scaling” approach. In some implementations, this approach can preserve the natural physical size differences between participants, creating a more authentic and perceptually accurate representation of the group. While normalizing everyone to the same size promotes a sense of equity, it can diminish the subtle social cues and sense of presence conveyed by a person's actual physical stature. This more advanced scaling method ensures that taller individuals appear taller and shorter individuals appear shorter, relative to one another, within the context of the shared virtual space.

To achieve this, the system first acquires participant scale data for each remote participant. This data can be obtained in several ways. In some implementations, a user can enter their height into a user profile, and this metadata is transmitted to other terminals in the meeting. In some implementations, a remote participant's terminal can use its camera and/or depth sensors to automatically estimate a physical size characteristic. For example, the terminal could measure the participant's seated torso height or the width of their shoulders and transmit this measurement as participant scale data along with the video stream.

However, the final rendered size may not be based on the remote participant's data alone. Instead, the final rendered size can also be a function of the local viewing environment. The system can determine a display characteristic of the local display, such as its physical diagonal size and aspect ratio. This can be a factor because rendering a 6-foot-tall person at their true scale on a 27-inch desktop monitor would result in a very small image, while rendering them on an 85-inch conference room display might make them appear unnaturally large. The system can use the display characteristic to calculate a global scaling factor for the entire scene, ensuring all participants are rendered at a comfortable and appropriate size for that specific display.

Once the global scaling factor is established, the system can apply a relative adjustment for each individual based on their specific participant scale data. The scaling algorithm can use the global factor as a baseline for an average-sized person and then modulates the scaling up or down. A participant whose scale data indicates they are taller than average can be rendered slightly larger than the baseline, while a participant who is shorter than average can be rendered slightly smaller. This can ensure that the relative size proportions between all participants are maintained.

In some implementations, eyeline alignment to the predetermined eyeline height is still performed as a separate step. This means that while participants' eyelines are co-planar to enable direct gaze, the rendered size of their head, shoulders, and torso can differ in proportion to their real-world size. The combination of relative scaling with consistent eyeline alignment can create the illusion of a group of people of varying heights all sitting at a level virtual table.

For example, in a meeting between three participants including Sarah, whose scale data indicates a height of 5′4″, Mark, with a height of 6′2″, and David, at 5′9″. They are being viewed on a 55-inch display. The system first determines a baseline scale appropriate for the 55-inch screen. The system then uses the participant scale data to render Mark approximately 10% larger than the baseline, David at the baseline, and Sarah approximately 5% smaller than the baseline. Although their eyes are all aligned along the same horizontal line on the display, the local viewer can perceive Mark as the tallest person in the group and Sarah as the shortest, mirroring the physical reality.

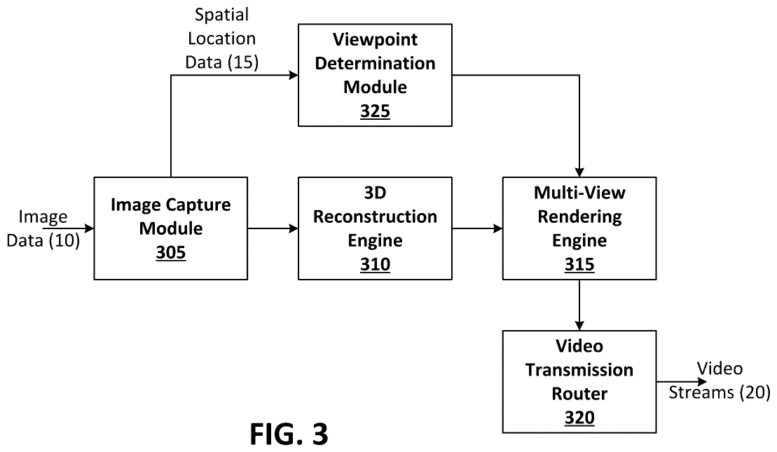

FIG. 3 is a block diagram illustrating a system flow for capturing a local participant and generating video streams for remote participants according to at least one example implementation. As shown in FIG. 3, the dataflow includes an image capture module 305 block, a 3D reconstruction engine 310 block, a multi-view rendering engine 315 block, a video transmission router 320 block, and a viewpoint determination module 325 block. FIG. 3 illustrates the system architecture and data flow for capturing the local participant and generating a plurality of unique, gaze-corrected video streams for transmission to remote participants. This process is the counterpart to the flow described in FIG. 2. While the system in FIG. 2 consumes and processes video from remote participants to create an immersive scene for the local user, the system in FIG. 3 generates the outgoing video streams that enable that same immersive experience for the remote users, as conceptually shown in FIG. 1B.

The primary technical challenge addressed by this system flow is the problem of gaze-misalignment, or the lack of true eye contact, in conventional video conferencing. A standard single webcam captures a user looking down at their screen, not directly at the remote participants. The architecture shown in FIG. 3 can be configured to overcome this by creating multiple “virtual cameras.” Instead of sending one video stream, this system synthesizes a unique, perspective-correct video stream for each remote participant, ensuring that when the local user looks at someone on their screen, the remote participant receives a video feed that appears as direct eye contact.

The dataflow begins with the capture of high-fidelity image data of the local participant from multiple physical cameras. This data is then used to create a real-time 3D model of the participant. In parallel, the system uses the on-screen location of the remote participants (as determined by the flow in FIG. 2) to calculate the precise viewpoint for each virtual camera. Finally, a rendering engine uses the 3D model and the calculated viewpoints to generate multiple video streams that are routed to their corresponding remote participants.

In some implementations, image capture module 305 can be configured to generate the outgoing video streams of the local participant. For example, image capture module 305 can function as the sensory input for the system, responsible for capturing the raw, high-fidelity visual information that forms the basis for the 3D reconstruction and novel view synthesis process. image capture module 305 can receive image data 10, which represents the light captured from the physical environment, particularly the local participant (e.g., participant 110-4 shown in FIGS. 1B and 1C), and forwards this data to the 3D reconstruction engine 310.

Image data 10 can represent the raw, multi-perspective visual information captured by the plurality of physical cameras within the image capture module 305. Image data 10 is not a single video feed, but rather a set of time-synchronized image frames, with each frame in the set captured from a different physical camera at substantially the same instant. This collection of images can include the necessary parallax and texture detail, representing a multi-view snapshot of the local participant's pose and expression.

Image capture module 305 can include a plurality of physical cameras. These cameras can be strategically positioned around display 105 to capture the local participant from multiple distinct angles substantially simultaneously. The cameras may be high-resolution RGB sensors capable of capturing detailed texture and color information. Image capture module 305 can include hardware and software for synchronizing the shutters of these cameras, ensuring that images in a given set are captured at substantially the same moment in time. This temporal synchronization can be important for the subsequent 3D reconstruction, as it provides a consistent, multi-perspective snapshot of the participant's pose and expression.

In some implementations, image capture module 305 can continuously capture sets of synchronized frames at a high rate (e.g., 30 or 60 times per second). Each set of frames constitutes the image data 10 for a single moment in time. This data can be more than just a single video feed. Instead, image data 10 can be a collection of several video feeds, each providing a slightly different parallax view of the local participant. This multi-view data contains the depth information that the 3D reconstruction engine 310 can use to build a volumetric model.

For example, if the local participant smiles, the Image capture module 305, which may consist of six physical cameras, can capture six distinct, time-stamped images of that smile at substantially the same time. A camera positioned on the upper left can capture a slightly different angle of the smile than a camera positioned on the upper right. This set of six synchronized images, containing subtle perspective shifts, can be packaged as image data 10 and passed to the 3D reconstruction engine 310. The 3D reconstruction engine 310 can then use techniques like stereoscopy across these multiple image pairs to accurately model the three-dimensional shape of the participant's face.

In some implementations, 3D reconstruction engine 310 can be configured to transform the two-dimensional, multi-view image data 10 into a dynamic three-dimensional (3D) representation of the local participant. The 3D reconstruction engine 310 can be configured to receive the set of synchronized image frames from the image capture module 305 and, through a series of complex computations, generate a 3D model that can be viewed from arbitrary perspectives. The 3D reconstruction engine 310 can execute the novel view synthesis process, creating the digital asset that allows for the generation of multiple, unique virtual camera viewpoints.

In some implementations, the 3D reconstruction engine 310 can use multi-view stereo (MVS) algorithms to infer depth and geometry. Physical cameras are first calibrated, for example, by using a known calibration pattern (such as a checkerboard) to determine their precise 3D positions, orientations, and lens characteristics. During the conference, the 3D reconstruction engine 310 can identify corresponding feature points across the different captured images. By using the known, pre-calibrated positions and orientations of the physical cameras, the 3D reconstruction engine 310 can triangulate the 3D position of these points in space. This process can be repeated for a dense set of points to generate a detailed point cloud or mesh representing the surface geometry of the local participant. The color and texture information from the original images can then be projected and blended onto this mesh, creating a photorealistic, textured 3D model.

This reconstruction process can be performed in real-time, updating for every new set of frames captured by the image capture module 305 at, for example, a rate of 30 or 60 times per second. This high-speed processing, often accelerated by specialized hardware like graphics processing units (GPUs), can capture the nuances of the local participant's expressions, speech, and movements without perceptible lag. The output can be a continuous stream of updated 3D models, each representing a single moment in time.

Continuing the example, the 3D reconstruction engine 310 can receive six synchronized images of the local participant smiling. The 3D reconstruction engine 310 can compute depth maps from these images and fuse the depth maps into a single, cohesive 3D mesh. The 3D reconstruction engine 310 can then project the color information from the original images onto this mesh, texturing the color to create a photorealistic 3D model of the participant's smiling face. This complete 3D model for that specific frame is then passed to the multi-view rendering engine 315 for rendering.

In some implementations, the multi-view rendering engine 315 can be the component where the novel view synthesis is realized. multi-view rendering engine 315 can be configured to generate the plurality of unique 2D video streams that are transmitted to the remote participants. Multi-view rendering engine 315 can function as a graphics engine, receiving two time-synchronized inputs including the continuous stream of updated 3D models of the local participant from the 3D reconstruction engine 310, and the set of unique virtual camera viewpoint parameters from the viewpoint determination module 325. Multi-view rendering engine 315 can be configured to render the 3D model from each of these distinct viewpoints, producing an independent video stream 20 for each remote participant.

The video stream 20 can represent the final, processed output of the entire system flow shown in FIG. 3. The video stream 20 can be a plurality of independent video feeds, where each stream is a unique, perspective-correct rendering of the local participant generated for a specific remote participant. Each of the video streams 20 can be the result of rendering the 3D model from a distinct virtual camera viewpoint and is encoded and ready for transmission by the video transmission router 320.

In some implementations, the multi-view rendering engine 315 can be configured to operate a parallelized graphics pipeline. For each remote participant in the conference, the multi-view rendering engine 315 can establish a virtual camera defined by the viewpoint parameters (e.g., position, orientation, field of view) received from the viewpoint determination module 325. For each frame, multi-view rendering engine 315 uses the current 3D model of the local participant and performs a projection transformation for each virtual camera. This can involve applying a view and projection matrix to the vertices of the 3D mesh, effectively rendering a 2D image of the 3D model as it would appear from that camera's specific vantage point.

In some implementations, the multi-view rendering engine 315 can implement a “reconstruct once, render many” architecture. The computationally expensive task of 3D reconstruction is performed only once per frame by the 3D reconstruction engine 310. The multi-view rendering engine 315 then takes this single 3D asset and performs the relatively lightweight operation of rendering it from multiple perspectives. This approach can allow the system to scale and generate several unique, high-frame-rate video streams in real-time without requiring the prohibitive computational cost of performing a full reconstruction for each desired viewpoint.

Each virtual camera viewpoint 125-1, 125-2, 125-3 can be calculated to align with the eyeline of a specific remote participant 110-1, 110-2, 110-3 on the display. Therefore, the resulting rendered video stream shows the local participant appearing to look directly at that remote participant. The multi-view rendering engine 315 can be the component that executes this rendering, translating the geometric alignment of the virtual cameras into the final gaze-corrected video output.

Continuing the example, the multi-view rendering engine 315 can receive the single 3D model of the local participant's pose and expression (e.g., smile, torso position, face expression, hand gestures, and/or the like). The multi-view rendering engine 315 can also receive three unique sets of virtual camera parameters from the viewpoint determination module 325, corresponding to three remote participants rendered on the local display. In parallel, the multi-view rendering engine 315 can render the smiling 3D model three times including once from the left-aligned viewpoint, once from the center-aligned viewpoint, and once from the right-aligned viewpoint. The result is three distinct video streams, each showing the participant's pose and expression from a slightly different angle, matching the perspective of each remote viewer.

In some implementations, the output of the multi-view rendering engine 315 can be a plurality of independent, uncompressed 2D video streams. These streams can be synchronized and passed to the video transmission router 320, which is responsible for video encoding (e.g., using a codec like VP9 or AV1) and routing each unique stream over the network to its corresponding remote participant. The multi-view rendering engine 315 role can be to synthesize the raw visual data that, once transmitted, completes the immersive communication loop by providing a natural and engaging view of the local participant to everyone in the meeting.

The video transmission router 320 can be configured to manage the transmission of the newly generated video streams 20. The video transmission router 320 can receive the plurality of independent, uncompressed video streams from the multi-view rendering engine 315 and can be configured to prepare video streams for efficient transmission over the network. The video transmission router 320 can be configured to encode each stream and ensure that each unique, perspective-correct video feed is securely and accurately routed to its intended remote participant.

In some implementations, the multi-view rendering engine 315 can implement a “reconstruct once, render many” architecture as a performance optimization. The computationally expensive task of 3D reconstruction is performed only once per frame by the 3D reconstruction engine 310. The multi-view rendering engine 315 then takes this single 3D asset and performs the relatively lightweight operation of rendering it from multiple perspectives. This approach allows the system to scale and generate several unique, high-frame-rate video streams in real-time without requiring the prohibitive computational cost of performing a full reconstruction for each desired viewpoint.

In some implementations, the video transmission router 320 operates as a multi-stream media handler. In response to receiving the raw video frames for each unique viewpoint, video transmission router 320 can independently encode each stream using a real-time video codec (e.g., VP9, AV1). This compression can reduce the bandwidth required to transmit multiple high-resolution video feeds simultaneously. The video transmission router 320 can then packetize the compressed data and, associate each distinct stream with the network address or session identifier of the corresponding remote participant. This ensures that the video generated from the viewpoint of Participant A is transmitted only to Participant A's device, the video for Participant B is sent only to Participant B's device, and so on.

Continuing the example, the video transmission router 320 can receive the three distinct, uncompressed video streams of the local participant's pose and expression. The video transmission router 320 encodes the left-aligned stream, the center-aligned stream, and the right-aligned stream in parallel. The video transmission router 320 then forwards the encoded packets for the left-aligned stream to the first remote participant, the center-aligned stream to the second remote participant, and the right-aligned stream to the third remote participant. By successfully delivering these personalized video streams 20, the video transmission router 320 completes the process, enabling each remote viewer to experience natural, direct eye contact with the local participant.

The viewpoint determination module 325 can be configured to calculate the parameters for each virtual camera viewpoint (e.g., viewpoints 125-1, 125-2, 125-3 in FIG. 1B). The viewpoint determination module 325 can function as the bridge between the two major system flows of the invention, receiving spatial location data 15 from the remote participant rendering pipeline (FIG. 2) and providing calculated viewpoint parameters to the multi-view rendering Engine 315. The viewpoint determination module 325 can be configured to translate the 2D arrangement of remote viewers on the screen into the 3D positioning of the virtual cameras that will capture the local participant.

The spatial location data 15 can represent the link between the system's rendering of remote participants (FIG. 2) and the system's generation of video streams of the local participant (FIG. 3). The spatial location data 15 can be a continuous stream of information, provided by the spatial layout module 225, that contains the on-screen coordinates for where each remote participant is currently being rendered on display 105. For each participant, spatial location data 15 can specify their horizontal position and confirm that their eyeline is vertically aligned with the predetermined eyeline height 115. The spatial location data 15 can be the input used by the viewpoint determination module 325 to calculate the corresponding virtual camera viewpoint for each remote participant.

The input to the viewpoint determination module 325 is the spatial location data 15. This data, which is continuously provided by the spatial layout module 225 of FIG. 2, can include a real-time map of where each remote participant is currently being rendered on display 105. For each remote participant, this data can include their horizontal position and confirms their vertical alignment with the predetermined eyeline height 115. The viewpoint determination module 325 can use this positional information as the basis for its calculations.

In some implementations, for each set of incoming spatial location data corresponding to a remote participant, the viewpoint determination module 325 can be configured to calculate a full set of virtual camera parameters. This includes a 3D position (x, y, z coordinates) and an orientation or “look-at” vector. The calculation can be designed to place the virtual camera's origin at a point in space that is directly in front of the display and perfectly aligned, both horizontally and vertically, with the rendered eyeline of the remote participant. This geometric alignment can ensure that the video rendered from this viewpoint will appear as direct eye contact to that specific remote participant.

The operation of the viewpoint determination module 325 can be dynamic and responsive. If a remote participant leaves the call and the spatial layout module 225 re-centers the remaining participants, the viewpoint determination module 325 can receive the updated spatial location data 15 and recalculate the virtual camera viewpoints to match the new on-screen positions. This can ensure that the gaze-correction feature remains accurate and seamless throughout the meeting, even as the visual layout changes.

The operation of the viewpoint determination module 325 is dynamic and responsive. For example, if a remote participant's rendered position is animated to a new location on the display, the virtual camera viewpoint associated with that participant can be updated in real-time to track the movement. As the virtual camera position changes, the resulting video stream sent to that remote participant will show the local participant's perspective smoothly pivoting. Furthermore, if a participant leaves the call and the spatial layout module 225 re-centers the remaining participants, the viewpoint determination module 325 receives the updated spatial location data 15 and recalculates the virtual camera viewpoints to match the new on-screen positions. This ensures that the gaze-correction feature remains accurate and seamless throughout the meeting, even as the visual layout changes. This can also ensure a smoother transition for users, so the camera angles don't jump discreetly, which could be confusing or disorienting

Continuing the example with three remote participants, the viewpoint determination module 325 can receive three distinct sets of spatial location data 15. Based on the data for the participant on the left, viewpoint determination module 325 can calculate the parameters for a left-aligned virtual camera. For the center participant, viewpoint determination module 325 can calculate parameters for a center-aligned camera, and for the right participant, a right-aligned camera. These three unique sets of viewpoint parameters are then passed, in real-time, to the multi-view rendering engine 315, providing the multi-view rendering engine 315 with the perspectives used to render the three distinct, gaze-corrected video streams.

The incoming video feeds from remote participants, such as video streams 5, may be referred to as a “plurality of first video streams.” The outgoing, gaze-corrected video feeds generated by the system for each remote participant, such as video streams 20, may be referred to as a “plurality of second video streams.” The video transmission router 320, which encodes and routes each unique outgoing stream, can be considered part of a “multi-stream video routing infrastructure.” Furthermore, the system can be configured to operate within a “predetermined capture volume,” which defines an optimal three-dimensional space in front of the terminal where the local participant should be positioned for effective 3D reconstruction. If the system determines that the local participant has moved outside this volume (e.g., is too far away, too close, or too far off-center), the generation of the plurality of second video streams may be paused. In this fallback scenario, the system can instead transmit a single, standard video stream captured from one of the physical cameras, such as a “physical top-center camera,” to all remote participants. Additionally, when evaluating incoming video streams for quality, the system may determine a “cropping level.” This metric quantifies how much of a participant's body is visible. For instance, the “cropping level” can be calculated as the ratio of the visible torso height to the head height in the video frame, with a lower ratio indicating a higher, and potentially problematic, degree of cropping.

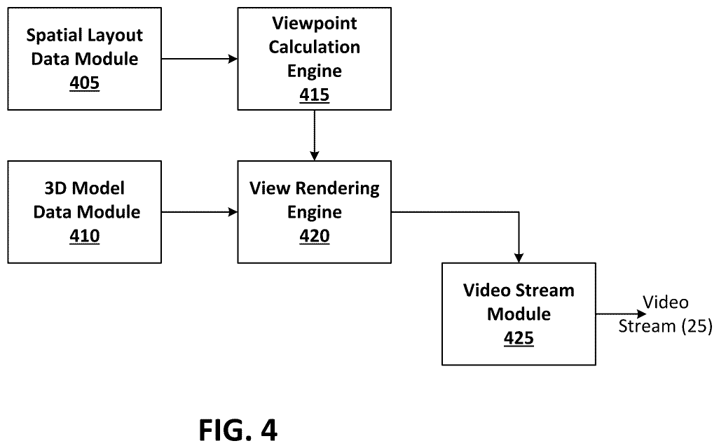

FIG. 4 is a block diagram illustrating a system flow for rendering a virtual camera view according to at least one example implementation. As shown in FIG. 4, the data flow includes the spatial layout data module 405 block, a 3D model data module 410 block, a viewpoint calculation engine 415 block, a view rendering engine 420 block, and a video stream module 425 block. FIG. 4 illustrates a more detailed or conceptual data flow for rendering a single virtual camera view. This process is performed in parallel for each remote participant by the broader system shown in FIG. 3. By breaking down the generation of one stream, FIG. 4 can clarify the logic of the novel view synthesis, showing how the on-screen position of a remote viewer is directly translated into a unique, perspective-correct video feed of the local participant. In this simplified flow, the components can be understood as representing a single instance of the operations managed by the broader system.

The flow in FIG. 4 begins with two distinct data inputs including the 2D spatial layout data for a remote participant and the 3D model data of the local participant. These inputs can be fed into a series of engines that first calculate the precise 3D parameters for a virtual camera and then use those parameters to render the 3D model into a 2D image. The resulting image is finally processed and output as a single, independent video stream destined for the corresponding remote participant.

FIG. 4 illustrates a more detailed or conceptual data flow for rendering a single virtual camera view, which is a process performed in parallel for each remote participant by the multi-view rendering engine 315 of FIG. 3. In this simplified flow, the components can be understood as representing a single instance of the operations managed by the broader system. For example, the view rendering engine 420 can represent the rendering task for a single viewpoint within the multi-view rendering engine 315, and the spatial layout data module 405 can represent the specific data input for one remote participant.

The spatial layout data module 405 can be the initial input component in the dataflow for generating a single virtual camera view. The spatial layout data module 405 can be configured to provide on-screen positional information for a single remote participant to the viewpoint calculation engine 415. The spatial layout data module 405 does not perform calculations itself. Instead, the spatial layout data module 405 can represent the source of the data that dictates where the virtual camera for this specific remote participant should be logically placed. The spatial layout data module 405 can be the component configured to ensure the subsequent viewpoint calculation is based on the actual, current rendered position of the remote viewer on the local display.

In some implementations, the spatial layout data module 405 can be a representation of the output generated by the spatial layout module 225 from FIG. 2. The spatial layout data module 405 can provide the same information as the spatial location data 15 that serves as input to the viewpoint determination module 325 in FIG. 3. This data for a single participant can include, for example, the x-coordinate for the center of the rendered participant and confirmation of the y-coordinate corresponding to the predetermined eyeline height 115. The spatial layout data module 405 can represent the data link that connects the remote participant rendering pipeline (FIG. 2) to the local participant capture pipeline (FIG. 3).

For example, if a remote participant is rendered on the left side of the display 105 as part of a three-person layout, the spatial layout module 225 can calculate the pixel coordinates for that position. The spatial layout data module 405 can then provide this specific set of coordinates (e.g., x=340, y=1080) for that one participant to the viewpoint calculation engine 415. This data serves as the direct input for the engine to calculate the parameters for the corresponding left-aligned virtual camera.

The spatial layout data module 405 can represent positional data for the rendering process. The accuracy of the final gaze cue for a given remote participant can be dependent on the accuracy of the data provided by the spatial layout data module 405. By ensuring a direct, one-to-one mapping between a remote participant's rendered location and the data used for the virtual camera calculation, the spatial layout data module 405 can be important to the system's ability to create a natural and convincing sense of eye contact.

The 3D model data module 410 can be configured to function as the second input to the view rendering process, providing the actual visual content to be rendered. While the spatial layout data module 405 and viewpoint calculation engine 415 can determine the perspective from which to view the local participant, the 3D model data module 410 can provide the subject of that view (e.g., a real-time, high-fidelity three-dimensional model of the local participant).

The 3D model data module 410 can be the direct data conduit from the 3D reconstruction engine 310 shown in FIG. 3. In some implementations, the 3D model data module 410 can represent the continuous stream of output from the 3D reconstruction engine 310 as a sequence of textured 3D meshes that accurately represent the local participant's geometry, pose, and expression at each moment in time. The data provided by the 3D model data module 410 can be a complete, render-ready digital asset, having been generated from the multi-view image data 10 captured by the image capture module 305.

Continuing the example, after the 3D reconstruction engine 310 has generated the 3D model of the local participant's pose and expression, the 3D model data module 410 can be configured to provide this time-synchronized 3D model data to the view rendering engine 420. The 3D model data module 410 can be configured to ensure that the rendering engine has the correct 3D representation of the participant for the frame being rendered.

The 3D model data module 410 can be configured to supply the photorealistic digital “actor” for the virtual scene. The quality and detail of the 3D model data are important for the final output as any imperfections in the reconstruction may be visible in the rendered video stream 25. Therefore, the 3D model data module 410 can be configured to provide the visual asset upon which the view rendering engine 420 operates to create a convincing, artifact-free novel view.

The viewpoint calculation engine 415 can be the active computational component that translates the 2D on-screen position of a remote participant into the 3D parameters used for a virtual camera. The viewpoint calculation engine 415 can receive the positional data from the spatial layout data module 405 and its output is the set of parameters that can define the perspective from which the view rendering engine 420 can render the final image. The viewpoint calculation engine 415 can be where the system's gaze-correction logic is executed.

The viewpoint calculation engine 415 can be a specific instance of the broader logic performed by the viewpoint determination module 325 in FIG. 3. In some implementations, the viewpoint calculation engine 415 can be take the 2D coordinates (x, y) of the remote participant's eyeline on the display and uses known geometric information about the terminal (e.g., the display's physical size, its position in 3D space relative to the local participant, and the target focal point (the local participant's face)) to calculate a 3D transformation matrix. This matrix can define the position and orientation of the virtual camera in world space, ensuring virtual is aimed at the local participant from a vantage point that aligns with the remote participant's on-screen location.

The viewpoint calculation engine 415 can be a specific instance of the broader logic performed by the viewpoint determination module 325 in FIG. 3. In some implementations, the viewpoint calculation engine 415 can be take the 2D coordinates (x, y) of the remote participant's eyeline on the display and uses known geometric information about the terminal (e.g., the display's physical size and resolution, the precise 3D positions and lens intrinsics of the physical cameras, and the display's position in 3D space relative to the local participant's expected location) to calculate a 3D transformation matrix. This matrix can define the position and orientation of the virtual camera in world space, ensuring the virtual camera is aimed at the local participant from a vantage point that aligns with the remote participant's on-screen location.

Continuing the example, in response to receiving the coordinates (e.g., x=340, y=1080) for the left-most participant, the viewpoint calculation engine 415 can compute the corresponding 3D position in front of the display. The viewpoint calculation engine 415 can then calculate an orientation vector that directs this virtual camera towards the estimated position of the local participant's head. The result can be a complete set of parameters (e.g., a view matrix) that, when used for rendering, will produce an image of the local participant as if they were captured by a physical camera floating at that exact left-aligned position.

The output of the viewpoint calculation engine 415 is not video data. Instead, the output can be a set of transformation parameters provided to the view rendering engine 420. The viewpoint calculation engine 415 can be real-time, continuous calculation allows the virtual camera to dynamically track the remote participant's tile if it moves on screen, maintaining a seamless and accurate eye-contact experience throughout the call.

The view rendering engine 420 can be configured to synthesize the final 2D video frame from the 3D inputs. The view rendering engine 420 can be the convergence point for the two parallel data streams in this flow, receiving the 3D model of the local participant from the 3D model data module 410 and the calculated virtual camera parameters from the viewpoint calculation engine 415. The view rendering engine 420 can be configured to execute the graphics rendering operations that project the 3D model into a 2D image from the specified unique perspective.

The view rendering engine 420 can represent a single rendering instance within the broader multi-view rendering engine 315 of FIG. 3. In some implementations, for each frame, the view rendering engine 420 can apply the view matrix (received from the viewpoint calculation engine 415) to the vertices of the 3D mesh (received from the 3D model data module 410). This projection transformation can map the 3D geometry onto a 2D plane, creating the final pixel data for the image as the image would be seen from the unique virtual camera viewpoint. This operation can be performed in real-time and can leverage a hardware-accelerated graphics pipeline (e.g., on a GPU) to maintain a high frame rate.

Continuing the example, the view rendering engine 420 can receive the 3D model of the local participant's pose and expression and the specific view matrix for the left-aligned virtual camera. The view rendering engine 420 can render the textured 3D mesh using this view matrix, producing a single 2D image of the participant's pose and expression as seen from the perspective of the remote participant on the left. This single rendered image constitutes one frame of the video stream 25 that will be sent to that specific participant.

The final output of the view rendering engine 420 can be a single, uncompressed 2D video frame, which is then passed to the video stream module 425 for encoding and transmission. The view rendering engine 420 can be configured to translate the abstract geometric and positional data into the final, tangible visual output that enables the system's goal of providing natural, gaze-corrected eye contact.

The video stream module 425 can represent the final stage in the dataflow of FIG. 4. The video stream module 425 can be configured to prepare a single, rendered 2D video frame for network transmission. The video stream module 425 can receive uncompressed image data from the view rendering engine 420 and processes the uncompressed image into the final video stream 25. The video stream module 425 can be configured to manage the final encoding and packetization of the perspective-correct video feed for a single remote participant.

The video stream module 425 can be an instance of one of the parallel operations performed by the video transmission router 320 in FIG. 3. In some implementations, the video stream module 425 can take the raw pixel data of the rendered frame and applies a real-time video codec (e.g., H.264, VP9, or AV1) to compress the data. This compression can ensure the stream can be transmitted efficiently over a network with limited bandwidth. The output of the video stream module 425 can be the final, transmittable video stream 25 (e.g., one of video streams 20).

Continuing the example, the video stream module 425 can receive the single, uncompressed 2D image of the local participant's pose and expression as rendered from the left-aligned viewpoint. The video stream module 425 can encode this single frame and subsequent frames in the sequence into a compressed video format. The resulting data packet, representing the video stream 25 (e.g., one of video streams 20), is then ready to be transmitted over the network exclusively to the remote participant on the left.

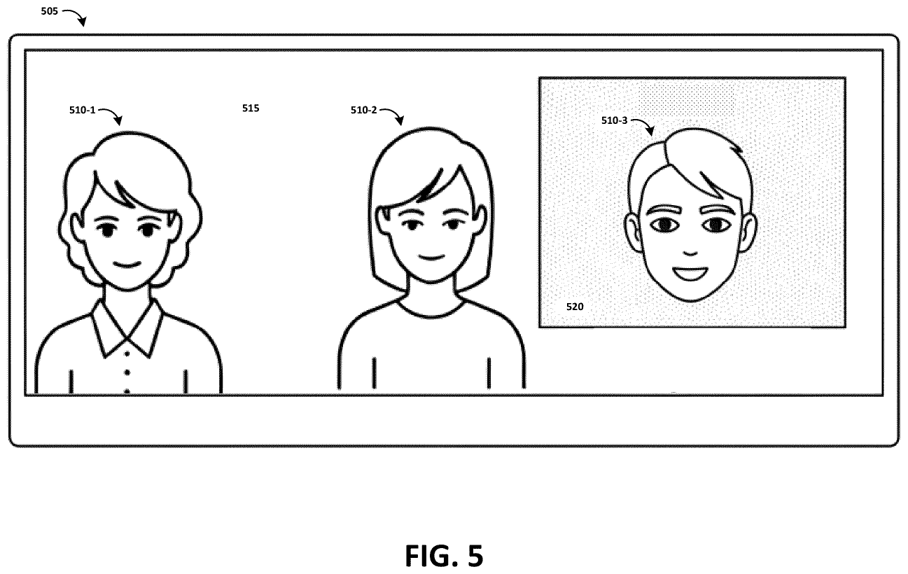

FIG. 5 is a diagram illustrating a display with a tiled view for a cropped participant according to at least one example implementation. FIG. 5 illustrates a fallback rendering mode on a display 505 for a remote participant whose video stream is poorly framed. FIG. 5 shows a mixed-rendering state, where the system adapts its display logic for one participant to maintain the overall visual quality of the immersive experience for the others. The display 505 shows two participants, 510-1 and 510-2, rendered in the standard immersive format, while a third participant, 510-3, is rendered in a special tiled view.

The participants 510-1 and 510-2 are rendered within the general display area 515. This rendering is consistent with the implementation shown in FIG. 1A, where each participant is segmented from their original background and composited over a unified virtual background. This creates the primary sense of a shared, cohesive space for the participants who are properly framed by their cameras. By contrast, participant 510-3 represents a scenario that the system has identified as problematic. An incoming video stream including participant 510-3 is likely cropped so tightly that it includes primarily the head of the participant, without a sufficient view of the torso. If rendered using the standard segmentation method, this would result in a disembodied or “floating head” effect on the unified background, which can be visually jarring and detracts from the sense of presence.

To mitigate this, the system can execute a fallback rendering operation. Participant 510-3 is transitioned from the unified background rendering to a distinct tiled view. This tiled view includes a localized virtual background 520, represented by the shaded or stippled area. The purpose of the localized background 520 is to ground the participant's head within a defined frame. This makes the tight cropping appear intentional, similar to a traditional video conference tile, and avoids the unnatural appearance of a head floating in the shared virtual space.

The existence of the localized background 520 is therefore a direct result of a conditional evaluation of the incoming video stream's quality. The system evaluates the cropping level of each participant's video feed, and if it determines that the cropping level exceeds a predetermined threshold corresponding to a head-only view, the system can trigger this alternative rendering style. This logic allows the system to be robust and handle a wide variety of camera setups from remote participants, which are common in hybrid meetings.

Alternatively, or in addition, the existence of the localized background 520 is therefore a direct result of a conditional evaluation of the incoming video stream's quality. The system evaluates the cropping level of each participant's video feed, for example, by using a machine learning model to identify both the head and torso and calculating the ratio of visible torso height to head height. If it determines that this ratio falls below a predetermined threshold (e.g., less than 0.5, indicating a head-only view), the system can trigger this alternative rendering style. This logic allows the system to be robust and handle a wide variety of camera setups from remote participants, which are common in hybrid meetings.

To provide flexibility, some implementations can include manual user controls, accessible via a touch controller or similar interface. A user may be provided with a control to toggle between the immersive experience and a standard grid-based layout. Another control can allow for global eyeline adjustment, enabling the user to manually shift the vertical position of the shared eyeline for all remote participants to improve comfort and the sense of co-presence.

Additional accessibility controls can be provided, such as options for caption placement (e.g., top or bottom of the display), adjustments for font sizes, and a ‘reduced animations’ mode to minimize motion for users sensitive to such effects. In some implementations, a side panel, such as a chat or participant list, can be docked as a ‘spatial participant,’ occupying one of the user slots in the main layout.

The system can also be configured to enhance the experience for remote participants who are not using a compatible terminal. For example, during the pre-join or ‘Green Room’ phase, the system can display prompts on the remote user's client, providing guidance on how to position themselves in front of their camera for optimal rendering in the immersive environment. Furthermore, when system-side visual effects like background removal are active, a notification can be displayed on the remote user's client to inform them that their own background may not be visible to others on the call.

Additional accessibility controls can be provided, such as options for caption placement (e.g., top or bottom of the display), adjustments for font sizes, and a ‘reduced animations’ mode to minimize motion for users sensitive to such effects. The system can also be configured to enhance the experience for remote participants who are not using a compatible terminal. For example, during the pre-join or ‘Green Room’ phase, the system can display prompts on the remote user's client, providing guidance on how to position themselves in front of their camera for optimal rendering in the immersive environment. Furthermore, when system-side visual effects like background removal are active, a notification can be displayed on the remote user's client to inform them that their own background may not be visible to others on the call.

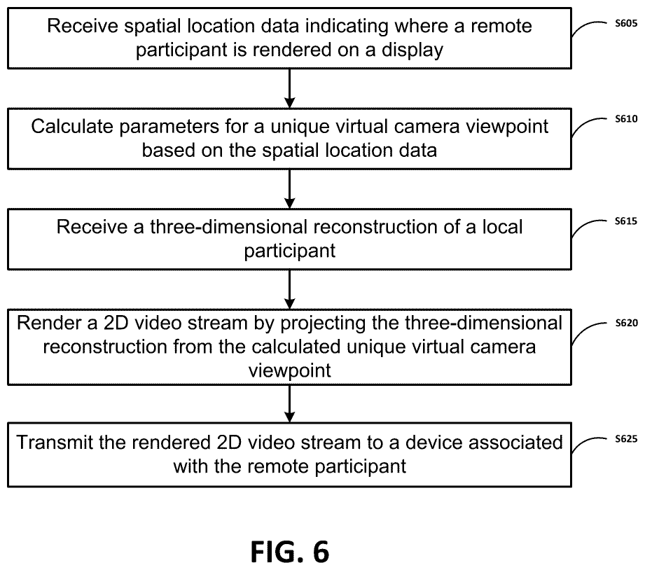

FIG. 6 is a flowchart illustrating a method for generating a video stream for a remote participant, consistent with disclosed implementations. As shown in FIG. 6, in step S605 receive spatial location data indicating where a remote participant is rendered on a display.

For example, this step can represent the data input that initiates the novel view generation process for a single remote participant. It is the action of obtaining the positional truth that can dictate the perspective of the virtual camera to be created. This step ensures that the subsequent calculations are based on the actual, current on-screen position of the remote viewer.

In some implementations, the reception of spatial location data can be associated with the spatial layout data module 405 in FIG. 4. This data originates from the spatial layout module 225 of FIG. 2, which can determine the on-screen arrangement of all participants. The data itself can include the coordinates (e.g., x and y pixel values) corresponding to the eyeline of the remote participant on display 105. This step therefore can represent the data handoff from the remote participant rendering pipeline to the local participant capture pipeline.

For example, in a three-person call, spatial layout module 225 can locate a remote participant on the far right of the display. Step S605 can be the process of receiving the specific coordinates for that position (e.g., x=1580, y=1080) from the layout module. This set of coordinates, representing the target for the local user's gaze, is then made available for the next step in the method, which is the calculation of the virtual camera parameters.

In step S610 calculate parameters for a unique virtual camera viewpoint based on the spatial location data. For example, following the reception of the positional data, step can S610 represent the active computational step where the system calculates the parameters for a unique virtual camera viewpoint based on the received spatial location data. This step can include translating the two-dimensional on-screen position of the remote participant into the three-dimensional parameters required to define a virtual camera. The output of this step is not a video image, but rather the set of data that will instruct the rendering engine on how to create the final, perspective-correct view.

This can be associated with the operations performed by the viewpoint calculation engine 415 in FIG. 4 and, more broadly, the viewpoint determination module 325 in FIG. 3. In some implementations, this step involves taking the 2D coordinates (x, y) of the remote participant's eyeline on the display and using pre-calibrated geometric information about the terminal (e.g., the display's physical size and its position relative to the local participant) to calculate a full 3D transformation matrix. This matrix can define the virtual camera's position and orientation, ensuring the virtual camera is aimed at the local participant from a vantage point that perfectly aligns with the remote participant's rendered on-screen location.

Continuing the example, having received the coordinates (e.g., x=1580, y=1080) for the remote participant on the far right in step S605, the method in step S610 computes the corresponding 3D position in space just in front of the display. It then calculates an orientation vector that directs this virtual camera towards the estimated position of the local participant's head. The result is a complete set of parameters (e.g., a view matrix) that will produce an image of the local participant as if captured by a physical camera floating at that exact right-aligned position.

In step S615 receive a three-dimensional reconstruction of a local participant. For example, in parallel with the viewpoint calculation, block S615 can represent the step of receiving a three-dimensional reconstruction of the local participant. This step provides the visual content that is to be rendered. While step S610 determines the perspective from which the local participant will be viewed, step S615 provides the subject of that view: a real-time, high-fidelity 3D model of the local participant.

This step can be associated with the 3D model data module 410 in FIG. 4. The 3D reconstruction itself can be generated by the 3D reconstruction engine 310 of FIG. 3. In some implementations, the data received in this step can be a sequence of textured 3D meshes that represent the local participant's geometry, pose, and expression at each moment in time, having been generated from the multi-view image data 10 captured by the image capture module 305.

Continuing the example, after the 3D reconstruction engine 310 has created the 3D model of the local participant's pose and expression, step S615 is the process of receiving this specific, time-synchronized 3D model data. This ensures that the rendering step S620 has the correct 3D representation of the participant for the exact frame that is being rendered from the unique viewpoint calculated in step S610.

In step S620 render a 2D video stream by projecting the three-dimensional reconstruction from the calculated unique virtual camera viewpoint. For example, step S620 can represent the synthesis step where the final 2D video stream is generated. This step can be the convergence point for the two parallel preceding steps, using the unique virtual camera viewpoint parameters calculated in step S610 to project the three-dimensional reconstruction received in step S615. The function of this step is to execute the graphics rendering operations that create the final 2D image from the specified unique perspective, which will then be transmitted to the remote participant.

This step can be associated with the view rendering engine 420 in FIG. 4 and can represent a single instance of the parallel rendering tasks managed by the broader multi-view rendering engine 315 of FIG. 3. In some implementations, for each frame, this step applies the view matrix (from step S610) to the vertices of the 3D mesh (from step S615). This projection transformation can map the 3D geometry onto a 2D plane, creating the pixel data for the image as the image would be seen from the unique virtual camera viewpoint. This operation can be performed using a hardware-accelerated graphics pipeline to maintain a high frame rate.

Continuing the example, the method in step S620 can receive the 3D model of the local participant's pose and expression and the specific view matrix for the right-aligned virtual camera. The method then renders the textured 3D mesh using this view matrix, producing a single 2D image of the pose and expression as seen from the perspective of the remote participant on the right. This single rendered image constitutes one frame of the unique video stream that will be sent to that specific participant.

In step S625 Transmit the rendered 2D video stream to a device associated with the remote participant. For example, step S625 can represent a step where the rendered 2D video stream is transmitted to a device associated with the corresponding remote participant. This step is the communication point of the novel view generation pipeline, responsible for preparing the newly synthesized video frame for efficient delivery over a network and ensuring it reaches its specific, intended recipient. This action completes the immersive communication loop for one remote participant.

This step can be associated with the video stream module 425 in FIG. 4 and can represent one of the parallel transmission tasks managed by the video transmission router 320 in FIG. 3. In some implementations, the step can take the raw pixel data of the rendered frame from step S620 and apply a real-time video codec (e.g., H.264, VP9, or AV1) to compress the data. This compression is important for transmitting the stream efficiently. The resulting data is then packetized and transmitted over the network to the specific address of the corresponding remote participant's device.

Continuing the example, the method in step S625 receives the uncompressed 2D image of the local participant's pose and expression as rendered from the right-aligned viewpoint. The method encodes this frame and subsequent frames in the sequence into a compressed video format. This resulting data packet is then transmitted over the network exclusively to the device of the remote participant on the right, ensuring they receive the unique, gaze-corrected view that was generated for them.

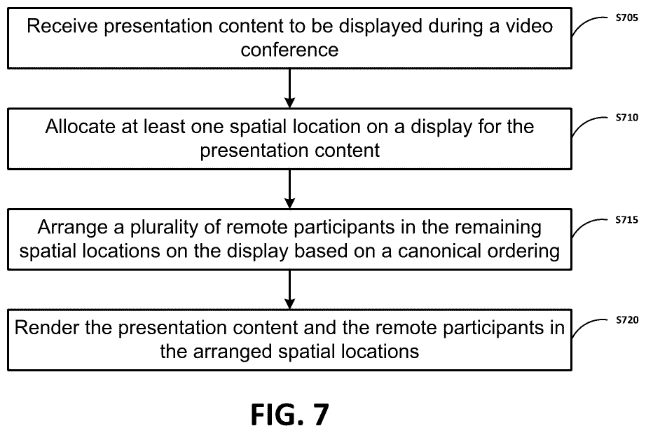

FIG. 7 is a flowchart illustrating a method for arranging presentation content on a display according to at least one example implementation. As shown in FIG. 7, in step S705 receive presentation content to be displayed during a video conference. For example, step S705 can represent a step where the system receives presentation content to be displayed during a video conference. This step can act as the trigger for the system to re-evaluate and adapt the on-screen layout from a purely participant-focused arrangement to a mixed content-and-participant arrangement. It is the detection of this new content type that initiates the entire layout adaptation process.

In some implementations, this step involves the reception of a new media stream along with metadata that identifies it as presentation content rather than a camera feed. This event would be managed by a component like the engine 215 of FIG. 2, which maintains the overall state of the meeting. In response to receiving this signal, the engine 215 can notify the spatial layout module 225 that the layout rules can be updated to accommodate the presentation content.

For example, if Participant A, who is already in a call with Participant B, decides to share a presentation, their device begins transmitting a new video stream containing the presentation slides. Step S705 is the method by which the local terminal receives this new stream and the associated metadata indicating its type. The engine 215 on the local terminal can recognize this event and prepare to alter the display layout from a two-person view to a one-person-plus-content view.

In step S710 allocate at least one spatial location on a display for the presentation content. For example, following the reception of presentation content, step S710 can represent the step where the system allocates at least one spatial location on the display for the presentation content. This is an active step where the layout management system reserves a specific, often prominent, portion of the screen real estate for the incoming presentation stream. This allocation can take precedence over the layout of the human participants and is the first action in physically reorganizing the on-screen elements to accommodate the new content.

This step can be associated with spatial layout module 225, as shown in FIG. 2. In response to being notified by engine 215 that presentation content is active, the spatial layout module 225 can switch from a participant-only layout algorithm to a mixed-media layout algorithm. This new algorithm can designate a significant zone of the display, for example, a large central or side-aligned block, for the presentation.

Continuing the example, after the system receives the presentation stream from Participant A in step S705, the method in step S710 can proceed to allocate a specific area for stream. Spatial layout module 225 can, for example, reserve the right half of the display 105 for Participant A's slides.

In step S715 arrange a plurality of remote participants in the remaining spatial locations on the display based on a canonical ordering. For example, after allocating space for presentation content, step S715 can represent the step of arranging the plurality of remote participants in the remaining spatial locations on the display. This step can ensure that the participants are not simply discarded but are repositioned in a logical and spatially consistent manner within the available screen area. The method can apply a consistent set of rules to this rearrangement to maintain the intuitiveness of the shared virtual space, even when it is partially occupied by content.

This step can be associated with the spatial layout module 225 in FIG. 2. In some implementations, the arrangement can be performed based on canonical ordering. Even with reduced space, the system can maintain the persistent, relative order of the participants. For example, if Participant B was to the right of Participant C before content was shared, they will remain to the right of Participant C in the new, compressed arrangement. This consistency is useful because the resulting spatial locations can inform the spatial location data 15 used by the viewpoint determination module 325 in FIG. 3 to calculate the virtual camera viewpoints. As the participants are rearranged in this step, their new positions are used to update the virtual cameras in real-time.

Continuing the example, after step S710 allocated the right half of the display to Participant A's presentation, the method in step S715 can take the remaining participant, Participant B, and arrange them in the available left half of the screen. Spatial layout module 225 can calculate a new central position for Participant B within this smaller zone. The new coordinates for Participant B are then used to update the corresponding virtual camera viewpoint for the local participant, ensuring that eye contact remains accurate even after the layout has adapted.

In step S720 render the presentation content and the remote participants in the arranged spatial locations. For example, step S720 can represent the step where the system renders the presentation content and the remote participants in their newly arranged spatial locations. This is the execution step where the abstract layout map, updated in the preceding steps, is translated into the final composite video frame that is displayed to the local user. This step can involve the simultaneous composition of multiple media types (e.g., the presentation stream and the various participant video streams) into a single, cohesive scene.

This step can be associated with the rendering engine 220 in FIG. 2. In some implementations, this step can take the complete layout map (with positions for both content and people) and all the relevant media streams. It composites them in layers, first rendering the unified background, then rendering the presentation content into its allocated location, and finally rendering the normalized and segmented video streams of the remote participants into their rearranged positions. This final composition can create complete visual experiences for the local users.

Continuing the example, after the right half of the display was allocated for Participant A's presentation and Participant B was arranged in the left half, the method in step S720 can execute the rendering. The rendering engine 220 can composite the presentation slides into the right-side block, and in the same frame, composites the normalized video stream of Participant B over the unified background in their new position on the left. The final video frame sent to the display 105 shows the presentation content and Participant B side-by-side in their new arrangement.

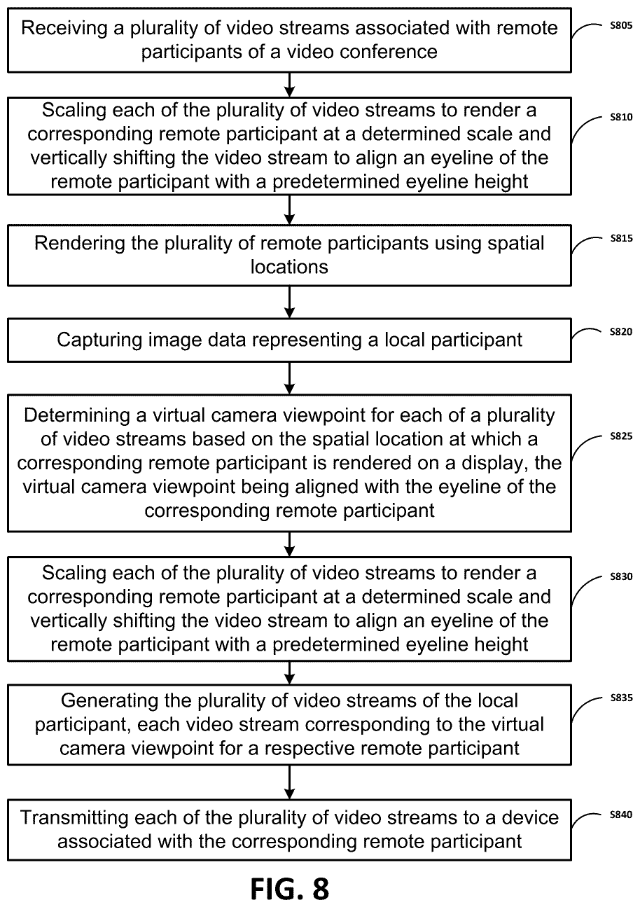

Example 1. FIG. 8 is a flowchart illustrating a method for enhancing a video conference according to at least one example implementation. As shown in FIG. 8, In step S805 receiving a plurality of video streams associated with remote participants of a video conference. In step S810 scaling each of the plurality of video streams to render a corresponding remote participant at a determined scale and vertically shifting the video stream to align an eyeline of the remote participant with a predetermined eyeline height. In step S815 rendering the plurality of remote participants using spatial locations. In step S820 capturing image data representing a local participant. In step S825 determining a virtual camera viewpoint for each of a plurality of video streams based on the spatial location at which a corresponding remote participant is rendered on a display, the virtual camera viewpoint being aligned with the eyeline of the corresponding remote participant. In step S830 generating the plurality of video streams of the local participant, each video stream corresponding to the virtual camera viewpoint for a respective remote participant. In step S835, transmitting each of the plurality of video streams to a device associated with the corresponding remote participant.

Example 2. The method of Example 1, wherein scaling each of the plurality of video streams can include scaling the video stream to render the corresponding remote participant at a scale that is consistent for each remote participant. For example, in some implementations, the scaling of each video stream is performed in such a way that all remote participants are rendered at a consistent scale relative to one another.

Example 3. The method of Example 1, wherein rendering the plurality of remote participants using spatial locations can include arranging the remote participants according to a canonical ordering service to maintain spatial consistency from the perspective of each remote participant.

Example 4. The method of Example 1, wherein generating a plurality of video streams of the local participant can include generating a plurality of novel view video streams and each novel view video stream can be generated from a virtual camera viewpoint generated from image data captured by a plurality of physical cameras.

Example 5. The method of Example 1 can further include receiving a plurality of audio streams associated with the remote participants and rendering audio from each audio stream such that it is spatially localized to the corresponding spatial location of the remote participant on the display. In some implementations, this is achieved by determining the geometric center of the rendered remote participant on the display and calculating an audio panning value based on the position of the geometric center relative to the known positions of physical left and right speakers. This ensures that as a participant's rendered location moves, the perceived audio source moves accordingly.

Alternatively, or in addition, the method of Example 1 can further include receiving a plurality of audio streams associated with the remote participants and rendering audio from each audio stream such that it is spatially localized to the corresponding spatial location of the remote participant on the display. In some implementations, the audio can be further enhanced by adjusting its loudness based on a perceived depth of the remote participant, creating a more immersive soundscape.

To further enhance the sense of co-presence, the system can implement spatial audio. Audio streams received from remote participants are rendered such that the sound appears to emanate from the corresponding participant's on-screen location. This can be achieved by calculating an audio panning value (e.g., left-right balance) based on the horizontal position of the rendered participant on the display relative to the physical speakers. Furthermore, if participants are rendered along a virtual curve to create an appearance of depth, the audio can be processed to reflect this, for instance by subtly adjusting the volume or reverb to make participants who appear farther away sound slightly more distant.

In some implementations, the physical environment of the local terminal is intentionally designed to enhance the immersive experience. This can include a curved table for in-room participants, shaped to improve interpersonal distance, provide better viewing angles to the display, and ensure optimal camera framing for a natural social dynamic. Furthermore, the physical setup may include a “middle wall” that obscures the bottom portion of the display, creating an effective 16:8 aspect ratio for visible pixels. This physical constraint necessitates a user interface design where critical elements are positioned to avoid this obscured region.

Example 6. The method of Example 1 can further include segmenting each of the remote participants from a background in the corresponding video stream and rendering the segmented remote participants over a unified background on the display.

Example 7. The method of Example 6 can further include in response to determining that an edge of a segmented remote participant is truncated, applying a visual fade effect to the truncated edge. In some implementations, this fade has a curved shape and is positioned relative to the user's body to appear more intentional. The treatment for side and top truncations may differ, with the top fade being smaller to avoid interfering with the participant's face.

Example 8. The method of Example 1, wherein scaling and vertically shifting the video stream can be performed continuously to maintain the determined scale and the predetermined eyeline height as the remote participant can move within the video stream.

Example 9. The method of Example 1 can further include evaluating each of the plurality of video streams to determine a cropping level of a corresponding remote participant; determining that the cropping level exceeds a predetermined threshold corresponding to a view of primarily a head of the remote participant; and in response to determining that the cropping level exceeds the predetermined threshold, transitioning a rendering of the remote participant to a tiled view having a localized virtual background. In some implementations, the transition between the standard rendering over a unified background and the tiled view is performed using a graceful visual effect, such as a crossfade, to avoid a jarring change for the local participant.

Example 10. The method of Example 1, wherein generating the plurality of video streams of the local participant can include performing a three-dimensional reconstruction of the local participant based on the captured image data and rendering each of the plurality of video streams from the three-dimensional reconstruction, wherein each video stream is rendered from its corresponding virtual camera viewpoint.

Example 11. The method of Example 1 can further include in response to determining that the local participant is positioned outside a predetermined capture volume for generating the plurality of video streams, transmitting a single video stream captured from a physical top-center camera to the remote participants in place of the plurality of video streams.

Example 12. The method of Example 1, wherein rendering the plurality of remote participants using spatial locations further can include applying a scale offset to a first remote participant of the plurality of remote participants relative to a second remote participant of the plurality of remote participants and applying a vertical offset to the first remote participant relative to the second remote participant, wherein the scale and vertical can offset position the plurality of remote participants along a virtual continuous curve to create an appearance of depth.

Alternatively, or in addition, the method of Example 1, wherein rendering the plurality of remote participants using spatial locations further can include applying a scale offset to a first remote participant of the plurality of remote participants relative to a second remote participant of the plurality of remote participants and applying a vertical offset to the first remote participant relative to the second remote participant, wherein the scale and vertical offsets position the plurality of remote participants along a virtual continuous curve to create an appearance of depth and provide more breathing room between participants.

Example 13. The method of Example 1, wherein rendering the plurality of remote participants using spatial locations can further include in response to receiving presentation content to be displayed, allocating at least one of the spatial locations to the presentation content and arranging the plurality of remote participants in remaining spatial locations based on a canonical ordering.

Example 14. The method of Example 1 can further include determining a canonical ordering for the local participant and the plurality of remote participants, wherein the canonical ordering defines a consistent relative spatial position between any two participants from the perspective of any other participant in a video conference to enable rendering of representative third-party gaze cues.

Example 15. The method of Example 1, wherein each of the plurality of video streams of the local participant can be an independent video stream and transmitting the plurality of video streams can include separately communicating each independent video stream to the device associated with the corresponding remote participant via a multi-stream video routing infrastructure.

Example 16. The method of Example 1, wherein generating the plurality of video streams of the local participant can include determining the virtual camera viewpoint for each of the plurality of video streams and transmitting each of the plurality of video streams are performed by at least one server computing device in a cloud computing environment.

Example 17. The method of Example 1, wherein receiving the plurality of video streams associated with the remote participants can include scaling each of the plurality of video streams and vertically shifting each of the plurality of video streams are performed by at least one server computing device in a cloud computing environment.

Example 18. The method of Example 1 can further include analyzing each of the plurality of video streams to determine visual characteristics of a corresponding remote participant and applying at least one machine learning-based visual correction to the plurality of video streams to normalize the visual characteristics, wherein rendering the plurality of remote participants creates a cohesive visual appearance among the remote participants.

Example 19. The method of Example 1 can further include capturing, using at least one camera, an image of a physical environment in which a display is located, analyzing the image to determine a color palette of the physical environment, and generating a unified background for rendering the plurality of remote participants. In some implementations, this unified background can be created using Generative AI to produce a design that is based on and complementary to the determined color palette of the physical interior.

Example 20. The method of Example 1 can further include in response to receiving a request to display a user interface panel allocating at least one of the spatial locations to the user interface panel and arranging the plurality of remote participants and the user interface panel according to a canonical ordering.

Example 21. The method of Example 1, wherein determining the spatial locations can include establishing a canonical ordering for the local participant and the remote participants, the canonical ordering defining a persistent spatial sequence for participants that is shared across devices in the video conference and arranging the representations of the remote participants on a display according to the canonical ordering to create a shared spatial frame of reference, the shared spatial frame of reference enables consistent interpretation of third-party gaze cues among participants.

Example 22. The method of Example 1, wherein determining the scale for each corresponding remote participant can include receiving participant scale data for each of the remote participants, the participant scale data indicating a physical size characteristic of the respective remote participant, determining a display characteristic of the display, and calculating the determined scale for each remote participant based on both the participant scale data and the display characteristic, such that the rendered representations of the remote participants maintain a relative size proportion to one another.

Example 23. A method can include any combination of one or more of Example 1 to Example 20.

Example 24. A non-transitory computer-readable storage medium comprising instructions stored thereon that, when executed by at least one processor, are configured to cause a computing system to perform the method of any of Examples 1-23.

Example 25. An apparatus comprising means for performing the method of any of Examples 1-23.

Example 26. An apparatus comprising at least one processor and at least one memory including computer program code, the at least one memory and the computer program code configured to, with the at least one processor, cause the apparatus at least to perform the method of any of Examples 1-23.

Alternatively, or in addition, the incoming video feeds from remote participants, such as video streams 5, may be referred to as a “plurality of first video streams.” The outgoing, gaze-corrected video feeds generated by the system for each remote participant may be referred to as a “plurality of second video streams.” The video transmission router 320, which encodes and routes each unique outgoing stream, can be considered part of a “personalized video stream delivery system.” Furthermore, the system can be configured to operate within an “optimal capture zone,” which defines a three-dimensional space in front of the terminal where the local participant should be positioned for effective 3D reconstruction. If the system determines that the local participant has moved outside this zone (e.g., is too far away, too close, or too far off-center), the generation of the plurality of second video streams may be paused. In this fallback scenario, the system can instead transmit a single, standard video stream captured from one of the physical cameras, such as a “physical top-center camera,” to all remote participants. Additionally, when evaluating incoming video streams for quality, the system may determine a “framing metric.” This metric quantifies how much of a participant's body is visible. For instance, the “framing metric” can be calculated as the ratio of the visible torso height to the head height in the video frame, with a lower ratio indicating a higher, and potentially problematic, degree of cropping.

Alternatively, or in addition, the incoming video feeds from remote participants, such as video streams 5, may be referred to as a “plurality of first video streams.” The outgoing, gaze-corrected video feeds generated by the system for each remote participant, may be referred to as a “plurality of second video streams.” The video transmission router 320, which encodes and routes each unique outgoing stream, can be considered part of a “multiple-stream transmission framework.” Furthermore, the system can be configured to operate within a “defined reconstruction space,” which defines an optimal three-dimensional space in front of the terminal where the local participant should be positioned for effective 3D reconstruction. If the system determines that the local participant has moved outside this space (e.g., is too far away, too close, or too far off-center), the generation of the plurality of second video streams may be paused. In this fallback scenario, the system can instead transmit a single, standard video stream captured from one of the physical cameras, such as a “physical top-center camera,” to all remote participants. Additionally, when evaluating incoming video streams for quality, the system may determine a “view composition ratio.” This metric quantifies how much of a participant's body is visible. For instance, the “view composition ratio” can be calculated as the ratio of the visible torso height to the head height in the video frame, with a lower ratio indicating a higher, and potentially problematic, degree of cropping.

Alternatively, or in addition, the incoming video feeds from remote participants may be referred to as a “plurality of first video streams.” The outgoing, gaze-corrected video feeds generated by the system for each remote participant, such as video streams 20, may be referred to as a “plurality of second video streams.” The video transmission router 320, which encodes and routes each unique outgoing stream, can be considered part of a “personalized video stream delivery system.” Furthermore, the system can be configured to operate within an “effective tracking area,” which defines an optimal three-dimensional space in front of the terminal where the local participant should be positioned for effective 3D reconstruction. If the system determines that the local participant has moved outside this area (e.g., is too far away, too close, or too far off-center), the generation of the plurality of second video streams may be paused. In this fallback scenario, the system can instead transmit a single, standard video stream captured from one of the physical cameras, such as a “physical top-center camera,” to all remote participants. Additionally, when evaluating incoming video streams for quality, the system may determine a “participant visibility score.” This metric quantifies how much of a participant's body is visible. For instance, the “participant visibility score” can be calculated as the ratio of the visible torso height to the head height in the video frame, with a lower score indicating a higher, and potentially problematic, degree of cropping.

FIG. 9 is a block diagram of a system for a video conference according to at least one example implementation. FIG. 9 illustrates, in block form, three-dimensional telepresence system 900 for conducting three-dimensional video conferencing between two users. In the implementation illustrated in FIG. 9, each terminal 920, corresponding to respective users (e.g., a first participant and a second participant) can communicate using network 990.

Three-dimensional telepresence system 900 shown in FIG. 9 can be computerized, where each of the illustrated components includes a computing device, or part of a computing device, that is configured to communicate with other computing devices via network 990. For example, each terminal 920 can include one or more computing devices, such as a desktop, notebook, or handheld computing device that is configured to transmit and receive data to/from other computing devices via network 990. In some implementations, each terminal 920 may be a special purpose teleconference device where each component of terminal 920 is disposed within the same housing. In some implementations, communication between each terminal 920 may be facilitated by one or more servers or computing clusters (not shown) which manage conferencing set-up, tear down, and/or scheduling. In some implementations, such as the implementation shown in FIG. 9, terminals 920 may communicate using point-to-point communication protocols.

In the implementation shown in FIG. 9, terminal 920 can be used by participants in a videoconference. In some implementations, the participants use identical terminals. For example, each participant may use the same model number of terminal 920 with the same configuration or specification, or terminals 920 that have been configured in a similar way to facilitate communication during the video conference. In some implementations, terminals used by participants may differ but are each configured to send and receive image and depth data and generate three-dimensional stereoscopic images without the use of head-mounted displays or three-dimensional glasses. For ease of discussion, the implementation of FIG. 9 presents identical terminals 920 on both ends of three-dimensional telepresence system 900.

In some implementations, terminal 920 includes display 925. In some implementations, display 925 can include a glasses-free lenticular three-dimensional display. Display 925 can include a microlens array that includes a plurality of microlenses. In some implementations, the microlenses of the microlens array can be used to generate a first display image viewable from a first location and a second display image viewable from a second location. A stereoscopic three-dimensional image can be produced by display 925 by rendering the first display image on a portion of a grid of pixels so as to be viewed through the microlens array from a first location corresponding to the location of a first eye of the user and a second display image on a portion of the grid of pixels so as to be viewed through the microlens array from a second location corresponding to the location of a second eye of the user such that the second display image represents a depth shift from the first display image to simulate parallax. For example, the grid of pixels may display a first display image intended to be seen through the microlens array by the left eye of a participant and the grid of pixels may display a second display image intended to be seen through the microlens array by the right eye of the participant. The first and second locations can be based on a location (e.g., a lateral/vertical location, a position, a depth, a location of a left or right eye) of the viewer with respect to the display. In some implementations, first and second directions for generating the first and second display images can be determined by selecting certain pixels from an array of pixels associated with the microlens array.

In some implementations, the microlens array can include a plurality of microlens pairs that include two microlenses and display 925 may use at least two of the microlenses for displaying images. In some implementations, processing device 930 may select a set of outgoing rays through which an image may be viewed through the microlenses to display a left eye image and right eye image based on location information corresponding to the position of the participant relative to display 925 (the location may be captured by camera assembly 980 consistent with disclosed implementations). In some implementations, each of a plurality of microlenses can cover (e.g., can be disposed over or associated with) some number of pixels, such that each pixel is visible from some limited subset of directions in front of the display 925. If the location of the observer is known, the subset of pixels under each lens (across the entire display 925) that is visible from one eye, and the subset of pixels across the display 925 that is visible from the other eye can be identified. By selecting for each pixel, the appropriate rendered image corresponding to the virtual view that would be seen from the user's eye locations, each eye can view the correct image.

The processing device 930 may include one or more central processing units, graphics processing units, other types of processing units, or combinations thereof. In some implementations, the location of the user with respect to the terminal, to determine a direction for simultaneously projecting at least two images to the user of the terminal via the microlenses, can be determined using a variety of mechanisms. For example, an infrared tracking system can use one or more markers coupled to the user (e.g., reflective markers attached to glasses or headwear of the user). As another example, an infrared camera can be used. The infrared camera can be configured with a relatively fast face detector that can be used to locate the eyes of the user in at least two images and triangulate location in 3D. As yet another example, color pixels (e.g., RGB pixels) and a depth sensor can be used to determine (e.g., directly determine) location information of the user. In some implementations, the frame rate for accurate tracking using such a system can be at least 60 Hz (e.g., 120 Hz or more).

In some implementations, display 925 can include a switchable transparent lenticular three-dimensional display. Display 925, in such implementations, may allow for placement of the camera assembly 980 behind display 925 to simulate eye contact during the videoconference. In some implementations, display 925 can include organic light emitting diodes (OLEDs) that are small enough to not be easily detected by a human eye or a camera lens thereby making display 925 effectively transparent. Such OLEDs may also be of sufficient brightness such that when they are illuminated, the area for the light they emit is significantly larger than their respective areas. As a result, the OLEDs, while not easily visible by a human eye or a camera lens, are sufficiently bright to illuminate display 925 with a rendered image without gaps in the displayed image. In a switchable transparent lenticular three-dimensional display, the OLEDs may be embedded in a glass substrate such that glass is disposed between consecutive rows of the OLEDs. This arrangement results in display 925 being transparent when the OLEDs are not illuminated but opaque (due to the image displayed on display 925) when illuminated.

In implementations where camera assembly 980 is positioned behind display 925, the camera assembly 980 may not be able to capture visible light and infrared light when the OLEDs are illuminated. In implementations where display 925 includes a switchable transparent lenticular three-dimensional display, processing device 930 may synchronize illumination of the OLEDs of display 925 with camera assembly 980 so that when the OLEDs are illuminated, camera assembly 980 does not capture visible light or infrared light but when the OLEDs are not illuminated, camera assembly 980 captures visible light and infrared light for determining image data, depth data and/or location data consistent with disclosed implementations. Processing device 930 may synchronize illumination of the OLEDs of display 925 with the image capture of camera assembly 980 at a rate faster than detectable by the human eye such as 90 frames per second, for example.

Since display 925 is a lenticular display, if camera assembly 980 were positioned behind a non-switchable transparent lenticular three-dimensional display, the lenticular nature of display 925 may create distortions in the visible light and infrared light captured by camera assembly 980. As a result, in some implementations, display 925 can be a switchable transparent lenticular three-dimensional display. In switchable transparent lenticular three-dimensional display implementations, the microlenses of the microlens array can be made of a first material and a second material. For example, at least some of the microlenses can be made of the first material and at least some of the microlenses can be made from the second material. The first material may be a material that is unaffected (e.g., substantially unaffected) by electrical current while the second material may be affected (e.g., substantially affected) by electrical current. The first material and the second material may have different indices of refraction when no current is applied to the second material. This can result in refraction at the boundaries between the microlenses of the first material and the second material thereby creating a lenticular display. When a current is applied to the second material, the current may cause the index of refraction of the second material to change to be the same as the index of refraction of the first material, neutralizing the lenticular nature of display 925 such that the two materials form a single rectangular slab of homogenous refraction, permitting the image on the display to pass through undistorted.

In some implementations, the current is applied to both the first material and the second material, where the current has the above-described effect on the second material and has no effect on the first material. Thus, when display 925 projects an image (e.g., its OLEDs are illuminated), processing device 930 may not apply a current to the microlens array and the display 925 may function as a lenticular array (e.g., when turned on). When the OLEDs of display 925 are not illuminated and processing device 930 commands the camera assembly 980 to capture visible light and infrared light, processing device 930 may cause a current to be applied to display 925 affecting the microlenses made of the second material. The application of current can change the indices of refraction for the microlenses made of the second material and the display 925 may not function as a lenticular array (e.g., display 925 may be transparent or function as a clear pane of glass without a lenticular effect).

In some implementations, terminal 920 can include processing device 930. Processing device 930 may perform functions and operations to command (e.g., trigger) display 925 to display images. In some implementations, processing device 930 may be in communication with camera assembly 980 to receive raw data representing the position and location of a user of terminal 920. Processing device 930 may also be in communication with network adapter 960 to receive image data and depth data from other terminals 920 participating in a videoconference. Processing device 930 may use the position and location data received from camera assembly 980 and the image data and depth data from network adapter 960 to render three-dimensional stereoscopic images on display 925, consistent with disclosed implementations.

In some implementations, processing device 930 may perform functions and operations to translate raw data received from camera assembly 980 into image data, depth data, and/or location data that may be communicated to other terminals 920 in a videoconference via network adapter 960. For example, during a videoconference, camera assembly 980 may capture visible light and/or infrared light reflected by a user of terminal 920. The camera assembly 980 may send electronic signals corresponding to the captured visible light and/or infrared light to processing device 930. Processing device 930 may analyze the captured visible light and/or infrared light and determine image data (e.g., data corresponding to RGB values for a set of pixels that can be rendered as an image) and/or depth data (e.g., data corresponding to the depth of each of the RGB values for the set pixels in a rendered image). In some implementations, processing device 930 may compress or encode the image data and/or depth data so that it requires less memory or bandwidth before it communicates the image data or the depth data over network 990. Likewise, processing device 930 may decompress or decode received image data or depth data before processing device 930 renders stereoscopic three-dimensional images.

According to some implementations, terminal 920 can include speaker assembly 940 and microphone assembly 950. Speaker assembly 940 may project audio corresponding to audio data received from other terminals 920 in a videoconference. The speaker assembly 940 may include one or more speakers that can be positioned in multiple locations to, for example, project directional audio. Microphone assembly 950 may capture audio corresponding to a user of terminal 920. The microphone assembly 950 may include one or more speakers that can be positioned in multiple locations to, for example, project directional audio. In some implementations, a processing unit (e.g., processing device 930) may compress or encode audio captured by microphone assembly 950 and communicated to other terminals 920 participating in the videoconference via network adapter 960 and network 990.

Terminal 920 can also include I/O devices 970. I/O devices 970 can include input and/or output devices for controlling the videoconference in which terminal 920 is participating. For example, I/O devices 970 can include buttons or touch screens which can be used to adjust contrast, brightness, or zoom of display 925. I/O devices 970 can also include a keyboard interface which may be used to annotate images rendered on display 925, or annotations to communicate to other terminals 920 participating in a videoconference.

According to some implementations, terminal 920 includes camera assembly 980. Camera assembly 980 can include one or more camera units. In some implementations, camera assembly 980 includes some camera units that are positioned behind the display 925 and one or more camera units that are positioned adjacent to the perimeter of display 925 (i.e., camera units that are not positioned behind the camera assembly 980). For example, camera assembly 980 can include one camera unit, three camera units, or six camera units. Each camera unit of camera assembly 980 can include an image sensor, an infrared sensor, and/or an infrared emitter. FIG. 4, discussed below, describes one implementation of a camera unit in more detail.

In some implementations, terminal 920 can include memory 985. Memory 985 may be a volatile memory unit or units or nonvolatile memory units or units depending on the implementation. Memory 985 may be any form of computer readable medium such as a magnetic or optical disk, or solid-state memory. According to some implementations, memory 985 may store instructions that cause the processing device 930 to perform functions and operations consistent with disclosed implementations.

In some implementations, terminals 920 of three-dimensional telepresence system 900 communicate various forms of data between each other to facilitate videoconferencing. In some implementations, terminals 920 may communicate image data, depth data, audio data, and/or location data corresponding to each respective user of terminal 920. Processing device 930 of each terminal 920 may use received image data, depth data, and/or location data to render stereoscopic three-dimensional images on display 925. Processing device 930 can interpret audio data to command speaker assembly 940 to project audio corresponding to the audio data. In some implementations, the image data, depth data, audio data, and/or location data may be compressed or encoded and processing device 930 may perform functions and operations to decompress or decode the data. In some implementations, image data may be a standard image format such as JPEG or MPEG, for example. The depth data can be, in some implementations, a matrix specifying depth values for each pixel of the image data in a one-to-one correspondence for example. Likewise, the audio data may be a standard audio streaming format as known in the art and may employ in some implementations voice over internet protocol (VOIP) techniques.

Depending on the implementation, network 990 can include one or more of any type of network, such as one or more local area networks, wide area networks, personal area networks, telephone networks, and/or the Internet, which can be accessed via any available wired and/or wireless communication protocols. For example, network 990 can include an Internet connection through which each terminal 920 communicate. Any other combination of networks, including secured and unsecured network communication links are contemplated for use in the systems described herein.

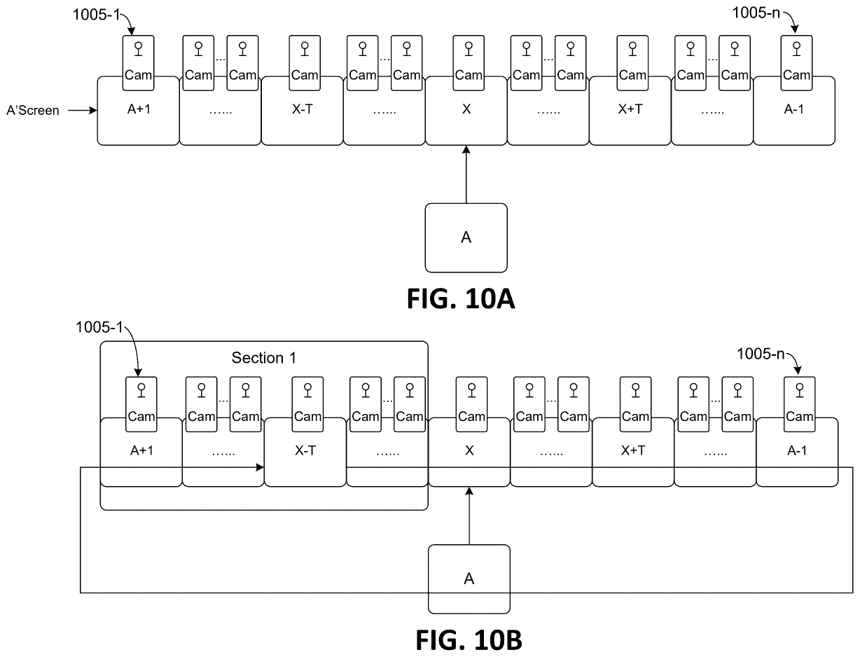

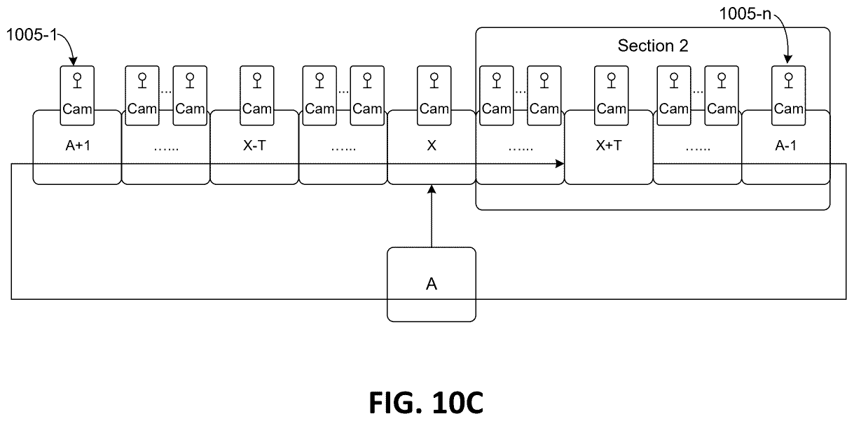

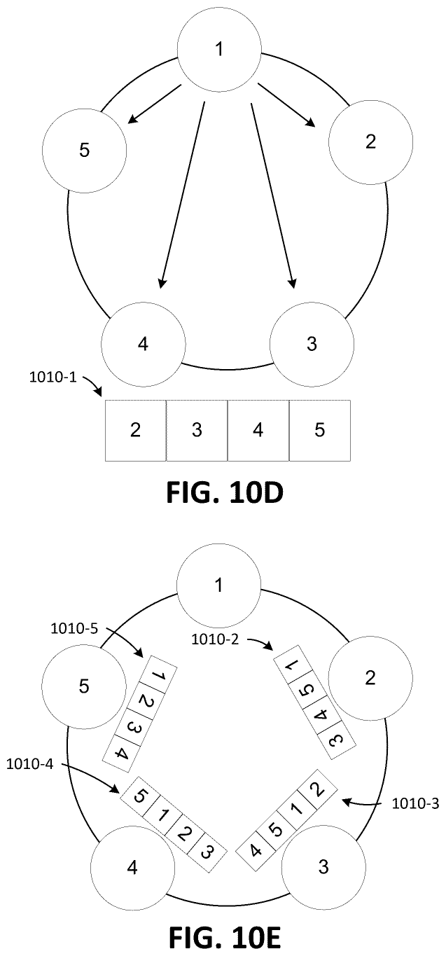

FIG. 10A, FIG. 10B, and FIG. 10C illustrate a block diagram of a multi-camera display arrangement according to at least one example implementation. As shown in FIGS. 10A-10C displays A+1, . . . , X−T, . . . , X, . . . X+T, . . . , A−1 each have an associated camera 1005-1, . . . , 1005-n. In some implementations, the multi-camera display arrangement can maintain representative remote attendee gaze cues for n attendees in a video conferencing system. In some implementations, remote attendees can be rendered in the same order on all attendees displays (or tiles) with associated cameras 1005-1, . . . , 1005-n. In some implementations, local attendee A can be in a hybrid video conference with n remote attendees being rendered on displays A+1, . . . , X−T, . . . , X, . . . X+T, . . . , A−1. In some implementations displays A+1, . . . , X−T, . . . , X, . . . X+T, . . . , A−1 can be implemented as tiles as discussed above.

When local attendee A looks at remote attendee rendered on display X, the remaining remote attendees in the hybrid video conference can see local attendee A looking in the direction of the remote attendee rendered on display X on the remote display of the respective remote attendee.

For example, remote attendees rendered on displays to the left of display X (e.g., displays A+1, . . . , X−T, . . . identified as section 1 of FIG. 10B) can view local attendee A looking to the left, from the respective remote attendees associated camera 1005-1, . . . , 1005-n. Remote attendees can be rendered based on the same order as displays A+1, . . . , X−T, . . . , X, . . . X+T, . . . , A−1 at every location of the video conference. Therefore, on the local display of any remote attendee (e.g., the remote attendee rendered on display X−T), remote attendee X will be displayed to the left of local attendee A, because remote attendee X will be rendered before local attendee A when rendered on a display of a remote attendee. Therefore, each remote attendee can see local attendee A looking in the direction of remote attendee X.

For example, remote attendees rendered on displays to the right of display X (e.g., displays . . . , X+1, . . . , A−1 identified as section 2 of FIG. 10C) can view local attendee A looking to the right, from the respective remote attendees associated camera 1005-1, . . . , 1005-n. Remote attendees can be rendered based on the same order as displays A+1, . . . , X−T, . . . , X, . . . X+T, . . . , A−1 at every location of the video conference. Therefore, on the local display of any remote attendee (e.g., the remote attendee rendered on display X+1), remote attendee X will be displayed to the right of local attendee A, because remote attendee X will be rendered after local attendee A when rendered on a display of a remote attendee. Therefore, each remote attendee can see local attendee A looking in the direction of remote attendee X.

As mentioned above, local attendees can be associated with individual video feeds and the mapping or display order can be linear (e.g., left to right or right to left). In this implementation local attendees (e.g., local attendee A) can move. In some implementations, the mapping, display order, or render location can be modified. For example, if local attendee A moves to the left of remote attendee X−T, the mapping, display order, or render location can be modified based on the movement. Pictorially in FIGS. 10B and 10C, section 2 and section 3 can change based on the movement of local attendee A.

FIGS. 10D and 10E illustrate a block diagram of a display order according to at least one example implementation. The mapping, spatial mapping, display position, display order, display location, render position, render order, render location, and/or the like of the attendees can be from one of many perspectives. For example, the mapping, spatial mapping, display position, display order, display location, render position, render order, render location, and/or the like of the attendees can be viewed from above in a clockwise or counterclockwise circular rotation. FIGS. 10D and 10E illustrate attendees viewed from above and displayed in a counterclockwise circular rotation.

Referring to FIG. 10D, circle 1 can represent a local attendee(s) or attendee system and circles 2, 3, 4, and 5 can represent remote attendees or attendee systems. Display order 1010-1 shows the display order from the perspective of a local attendee (circle 1) where the display order 1010-1 is circles 2, 3, 4, and 5 or remote attendee 5, 4, 3, and 2. The display order for all of the attendees should be the same to ensure some of the features above (e.g., eye gaze direction) is consistent across all of the devices associated with the video conference. Therefore, referring to FIG. 10E, display order 1010-2 shows the display order from the perspective of a remote attendee (circle 2) where the display order 1010-2 is circles 3, 4, 5, and 1 or remote attendee 3, 4, 5, and local attendee 1. Display order 1010-3 shows the display order from the perspective of a remote attendee (circle 3) where the display order 1010-3 is circles 4, 5, 1 and 2 or remote attendee 4, 5, local attendee 1, and remote attendee 2. Display order 1010-4 shows the display order from the perspective of a remote attendee (circle 4) where the display order 1010-4 is circles 5, 1, 2, and 3 or remote attendee 5, local attendee 1, and remote attendee 2, 3. Display order 1010-5 shows the display order from the perspective of a remote attendee (circle 5) where the display order 1010-5 is circles 1, 2, 3, and 4 or local attendee 1, and remote attendee 2, 3, 4.

For example, referring to FIG. 10E, from the perspective of participant 5, participant 3 is to the right of 1 (e.g., 5's ordering is 1234). However, from the perspective of participant 2, participant 3 is to the left of 1 (e.g., 2's ordering is 3451). Therefore, if participant 1 turns their head to look at participant 3, participant 5 should see participant 1's head turn towards participant 5's right (which is participant 1's left). However, participant 2 should see participant 1's head turn towards participant 2's left (which is participant 1's right). In some implementations, considering canonical ordering, this works because participant 5 and participant 2 are receiving different video feeds from virtual cameras placed in different locations. Therefore, the head turn direction can appear correct to each participant. At the same time, the head turn direction looks different within each feed (e.g., participant 1 appears to turn to their own left in participant 5's feed but to their own right in participant 2's feed).

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently or simultaneously. In addition, the order of operations may be re-arranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

What is claimed is:

1. A method comprising:
receiving a plurality of first video streams associated with remote participants of a video conference;
scaling each of the first video streams to render a corresponding remote participant at a determined scale and vertically shifting the video stream to align an eyeline of the remote participant with a predetermined eyeline height;
rendering representations of the remote participants from the first video streams at determined spatial locations;
capturing image data representing a local participant;
determining a virtual camera viewpoint for each of a plurality of second video streams based on the spatial location at which a corresponding remote participant is rendered on a display, the virtual camera viewpoint being aligned with the eyeline of the corresponding remote participant;
generating the second video streams of the local participant, each of the second video streams corresponding to the virtual camera viewpoint for a respective remote participant; and
transmitting each of the second video streams to a device associated with the corresponding remote participant.

2. The method of claim 1, wherein scaling each of the first video streams includes scaling the first video streams to render the corresponding remote participant at a scale that is consistent for each remote participant.

3. The method of claim 1, wherein rendering the first video streams using spatial locations includes arranging the remote participants according to a canonical ordering service to maintain spatial consistency from a perspective of each remote participant.

4. The method of claim 1, wherein
generating the second video streams of the local participant includes generating a plurality of novel view video streams, and
each of the novel view video streams is generated from the virtual camera viewpoint generated from image data captured by a plurality of physical cameras.

5. The method of claim 1, further comprising:
receiving a plurality of audio streams associated with the remote participants; and
rendering audio from each audio stream such that it is spatially localized to the corresponding spatial location of the remote participant on the display.

6. The method of claim 1, further comprising:
segmenting each of the remote participants from a background in the corresponding video stream; and
rendering the segmented remote participants over a unified background on the display.

7. The method of claim 6, further comprising:
in response to determining that a truncated edge of a segmented remote participant is truncated, applying a visual fade effect to the truncated edge of the segmented remote participant to reduce visual artifacts associated with the truncation.

8. The method of claim 1, wherein
scaling and vertically shifting the video stream is performed continuously to maintain the determined scale, and
the predetermined eyeline height as the remote participant moves within the video stream.

9. The method of claim 1, further comprising:
evaluating each of the first video streams to determine a cropping level of a corresponding remote participant;
determining that the cropping level exceeds a predetermined threshold corresponding to a view of primarily a head of the remote participant; and
in response to determining that the cropping level exceeds the predetermined threshold, transitioning a rendering of a corresponding one of the first video streams to a tiled view having a localized virtual background.

10. The method of claim 1, wherein generating the second video streams of the local participant includes:
performing a three-dimensional reconstruction of the local participant based on the captured image data; and
rendering each of the second video streams from the three-dimensional reconstruction, wherein each video stream is rendered from a corresponding virtual camera viewpoint.

11. The method of claim 1, further comprising:
in response to determining that the local participant is positioned outside a predetermined capture volume for generating the second video streams, transmitting a single video stream captured from a physical top-center camera to the remote participants in place of the second video streams.

12. The method of claim 1, wherein rendering the plurality of first video streams using spatial locations further includes:
applying a scale offset to a first remote participant of the plurality of remote participants relative to a second remote participant of the plurality of remote participants; and
applying a vertical offset to the first remote participant relative to the second remote participant, wherein the scale and vertical offsets position the plurality of remote participants along a virtual continuous curve to create an appearance of depth.

13. The method of claim 1, wherein rendering the first video streams using spatial locations further includes:
in response to receiving presentation content to be displayed,
allocating at least one of the spatial locations to the presentation content, and
arranging the plurality of remote participants in remaining spatial locations based on a canonical ordering.

14. The method of claim 1, further comprising:
determining a canonical ordering for the local participant and the plurality of remote participants, wherein the canonical ordering defines a consistent relative spatial position between any two participants from a perspective of any other participant in a video conference to enable rendering of representative third-party gaze cues.

15. The method of claim 1, wherein
each of the second video streams of the local participant is an independent video stream, and
transmitting the second video streams includes separately communicating each independent video stream to the device associated with the corresponding remote participant via a multi-stream video routing infrastructure.

16. The method of claim 1, wherein generating the second video streams of the local participant includes,
determining the virtual camera viewpoint for each of the second video streams, and
transmitting each of the second video streams are performed by at least one server computing device in a cloud computing environment.

17. The method of claim 1, wherein receiving the first video streams associated with the remote participants includes,
scaling each of the first video streams, and
vertically shifting each of the first video streams are performed by at least one server computing device in a cloud computing environment.

18. The method of claim 1, further comprising:
analyzing each of the first video streams to determine visual characteristics of a corresponding remote participant; and
applying at least one machine learning-based visual correction to the first video streams to normalize the visual characteristics, wherein rendering the first video streams creates a cohesive visual appearance among the remote participants.

19. The method of claim 1, further comprising:
capturing, using at least one camera, an image of a physical environment in which a display is located;
analyzing the image to determine a color palette of the physical environment; and
generating a unified background for rendering the first video streams, the unified background being based on the determined color palette.

20. The method of claim 1, further comprising:
in response to receiving a request to display a user interface panel,
allocating at least one of the spatial locations to the user interface panel; and
arranging the plurality of remote participants and the user interface panel according to a canonical ordering.

21. The method of claim 1, wherein determining the spatial locations includes:
establishing a canonical ordering for the local participant and the remote participants, the canonical ordering defining a persistent spatial sequence for participants that is shared across devices in the video conference; and
arranging the representations of the remote participants on a display according to the canonical ordering to create a shared spatial frame of reference, the shared spatial frame of reference enables consistent interpretation of third-party gaze cues among participants.

22. The method of claim 1, wherein determining the scale for each corresponding remote participant includes:
receiving participant scale data for each of the remote participants, the participant scale data indicating a physical size characteristic of the respective remote participant;
determining a display characteristic of the display; and
calculating the determined scale for each remote participant based on both the participant scale data and the display characteristic, such that the rendered representations of the remote participants maintain a relative size proportion to one another.

23. A non-transitory computer-readable storage medium comprising instructions stored thereon that, when executed by at least one processor, are configured to cause a computing system to:
receive a plurality of first video streams associated with remote participants of a video conference;
scale each of the first video streams to render a corresponding remote participant at a determined scale and vertically shifting the video stream to align an eyeline of the remote participant with a predetermined eyeline height;
render representations of the remote participants from the first video streams at determined spatial locations;
capture image data representing a local participant;
determine a virtual camera viewpoint for each of a plurality of second video streams based on the spatial location at which a corresponding remote participant is rendered on a display, the virtual camera viewpoint being aligned with the eyeline of the corresponding remote participant;
generate the second video streams of the local participant, each of the second video streams corresponding to the virtual camera viewpoint for a respective remote participant; and
transmit each of the second video streams to a device associated with the corresponding remote participant.

24. An apparatus comprising at least one processor and at least one memory including computer program code, the at least one memory and the computer program code configured to, with the at least one processor, cause the apparatus to:
receive a plurality of first video streams associated with remote participants of a video conference;
scale each of the first video streams to render a corresponding remote participant at a determined scale and vertically shifting the video stream to align an eyeline of the remote participant with a predetermined eyeline height;
render representations of the remote participants from the first video streams at determined spatial locations;
capture image data representing a local participant;
determine a virtual camera viewpoint for each of a plurality of second video streams based on the spatial location at which a corresponding remote participant is rendered on a display, the virtual camera viewpoint being aligned with the eyeline of the corresponding remote participant;
generate the second video streams of the local participant, each of the second video streams corresponding to the virtual camera viewpoint for a respective remote participant; and
transmit each of the second video streams to a device associated with the corresponding remote participant.
